(19) United States
(12) Patent Application Publication
(10) Pub. No.: US 2026/0044588 A1
(43) Pub. Date: Feb. 12, 2026

(54) IMAGING DEVICE, IMAGING SYSTEM, METHOD, AND NON-TRANSITORY COMPUTER-READABLE STORAGE MEDIUM

(71) Applicant: CANON KABUSHIKI KAISHA, Tokyo (JP)

(72) Inventor: Hiroshi TOJO, Tokyo (JP)

(21) Appl. No.: 19/291,353

(22) Filed: Aug. 5, 2025

(30) Foreign Application Priority Data
Aug. 7, 2024 (JP) 2024-131207

(51) Int. Cl. G06F 21/32; G06F 16/583

(52) U.S. Cl. CPC G06F 21/32; G06F 16/583

(57) ABSTRACT

An imaging device configured to image a subject, the imaging device comprising at least one processor and at least one memory coupled to the at least one processor. The at least one memory stores instructions that, when executed by the at least one processor, cause the at least one processor to authenticate a user and, based on subject consent information in which user information of the authenticated user and consent information, which grants the user consent to use biometric information of the subject, are associated with each other, control use of the biometric information.

### BACKGROUND

### Field of the Technology

The present disclosure relates to an imaging device, an imaging system, a method, and a non-transitory computer-readable storage medium.

### Description of the Related Art

Artificial Intelligence (AI), which performs detection or estimation processing using parameters obtained by image learning, is known. AI can perform intelligent processing and determination equivalent to those of humans. Therefore, the utilization of AI has advanced in various fields in recent years. Meanwhile, there is an opinion that limitations should be placed on the use of biometric information (e.g., face images, face feature vectors, fingerprints, and irises) of subjects without consent of the subjects. At present, laws on the handling of biometric information of subjects are being developed in various countries and regions. Accordingly, Japanese Patent No. 6150019 discloses a method of obtaining consent information of a subject having biometric information and limiting the use of the biometric information based on the obtained consent information.

A scene in which a photographer images a subject with an imaging device is assumed. The subject would want to give consent information that consents to the use of biometric information (hereinafter, also simply referred to as consent information) for each photographer who is a user of the biometric information. The reason is that whether a photographer has the ability to properly handle the biometric information of the subject is a determination factor when the subject gives the consent information. For example, the subject would want to give consent information to a photographer who has the ability to properly handle the biometric information. In contrast, the subject would not want to give consent information to a photographer who does not have the ability to properly handle the biometric information. However, Japanese Patent No. 6150019 cannot satisfy the above needs of the subject, and poses a problem that consent information, which consents to the use of the biometric information of the subject, is given uniformly to all photographers.

### SUMMARY

Accordingly, the present disclosure aims to provide a technique that allows a specific target to use biometric information of a subject.

The present disclosure in a first aspect provides an imaging device configured to image a subject, the imaging device comprising at least one processor and at least one memory coupled to the at least one processor. The at least one memory stores instructions that, when executed by the at least one processor, cause the at least one processor to authenticate a user and, based on subject consent information in which user information of the authenticated user and consent information, which grants the user consent to use biometric information of the subject, are associated with each other, control use of the biometric information.

The present disclosure in a second aspect provides an imaging device configured to image a subject, the imaging device comprising at least one processor and at least one memory coupled to the at least one processor. The at least one memory stores instructions that, when executed by the at least one processor, cause the at least one processor to, based on subject consent information in which information of the imaging device and consent information, which grants the imaging device consent to use biometric information of the subject, are associated with each other, control use of the biometric information.

The present disclosure in a third aspect provides a method to control an imaging device configured to image a subject, method comprising authenticating a user and, based on subject consent information in which user information of the authenticated user and consent information, which grants the user consent to use biometric information of the subject, are associated with each other, controlling use of the biometric information.

The present disclosure in a fourth aspect provides a non-transitory computer-readable storage medium storing a computer program that, when read and executed by a computer, causes the computer to authenticate a user and, based on subject consent information in which user information of the authenticated user and consent information, which grants the user consent to use biometric information of the subject, are associated with each other, control use of the biometric information.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a front perspective view of an imaging device according to a first embodiment.

FIG. 1B is a back perspective view of the imaging device according to the first embodiment.

FIG. 1C is a schematic view of an imaging system according to the first embodiment.

FIG. 1D is a schematic view of the imaging system according to a second embodiment.

FIG. 2 is a sectional view of the imaging device taken along a YZ plane formed by a Y-axis and a Z-axis illustrated in FIG. 1A.

FIG. 3 is a block diagram illustrating an electrical configuration in the imaging device according to the first embodiment.

FIG. 4 is a view illustrating a functional configuration of the imaging device according to the first embodiment.

FIG. 5 is a block diagram illustrating a hardware configuration of a portable terminal according to the first embodiment.

FIG. 6 is a view illustrating a functional configuration of the portable terminal according to the first embodiment.

FIG. 7 is a flowchart for explaining processing to be executed by the imaging system according to the first embodiment.

FIG. 8 is a flowchart for explaining processing to be executed by the imaging device in step S701 of FIG. 7.

FIG. 9 is an example of a registered user information table according to the first embodiment.

FIG. 10 is an example of a registered user feature vector table according to the first embodiment.

FIG. 11 is a flowchart for explaining processing to be executed by the imaging device in step S702 of FIG. 7.

FIG. 12 is a flowchart for explaining user authentication processing to be executed by the imaging device according to the first embodiment.

FIG. 13 is a flowchart for explaining processing to be executed by the portable terminal according to the first embodiment.

FIG. 14 is an example of a confirmation message to be displayed on the portable terminal according to the first embodiment.

FIG. 15 is an example of consent information according to the first embodiment.

FIG. 16 is an example of subject consent information according to the first embodiment.

FIG. 17 is a flowchart for explaining processing to be executed by the imaging device in step S703 of FIG. 7.

FIG. 18 is an example of a biometric information usage management table according to the first embodiment.

FIG. 19 is a flowchart for explaining processing to be executed by the imaging device in step S704 of FIG. 7.

FIG. 20 is an example of a subject feature vector table according to the first embodiment.

FIG. 21 is a flowchart for explaining processing to be executed by the imaging device in step S704 of FIG. 7.

FIG. 22 is an example of a file format of a captured image according to the first embodiment.

FIG. 23 is a view illustrating a functional configuration of the imaging device according to the second embodiment.

FIG. 24 is a view illustrating a functional configuration of the portable terminal according to the second embodiment.

FIG. 25 is a view illustrating a functional configuration of a server according to the second embodiment.

FIG. 26 is a flowchart for explaining processing to be executed by the imaging device according to the second embodiment.

FIG. 27 is a flowchart for explaining processing to be executed by the portable terminal according to the second embodiment.

FIG. 28 is a flowchart for explaining processing to be executed by the server according to the second embodiment.

FIG. 29 is an example of the registered user information table according to the second embodiment.

FIG. 30 is an example of subject consent information according to the second embodiment.

FIG. 31 is an example of a confirmation message to be displayed on the portable terminal according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

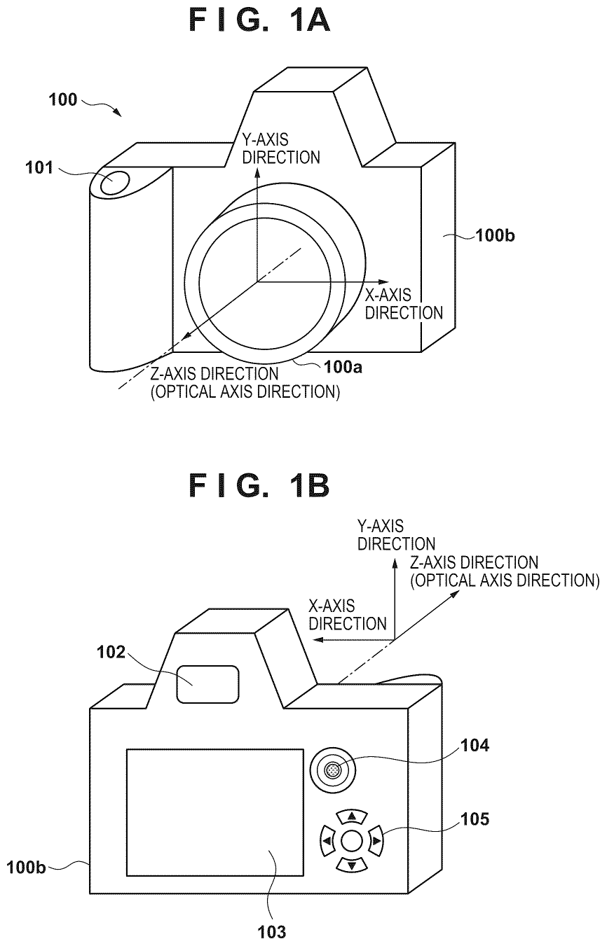

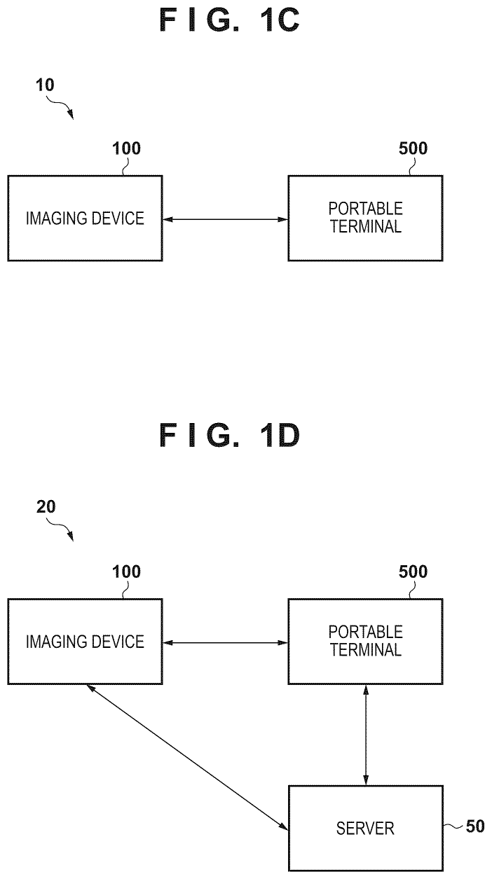

FIG. 1C is a schematic view of an imaging system according to a first embodiment. An imaging system 10 is a system that can control the use of biometric information of a subject. The imaging system 10 includes an imaging device 100, which images the subject, and a portable terminal 500. The imaging device 100 is a digital still camera, and is, for example, an interchangeable lens camera. The portable terminal 500 is a portable terminal belonging to the subject, and is, for example, any one of a Personal Computer (PC), a smartphone, and a tablet. The portable terminal 500 is not limited to a portable terminal belonging to the subject, and may be, for example, another terminal not belonging to the subject (hereinafter, also referred to as a terminal other than the portable terminal). The terminal other than the portable terminal 500 is, for example, a terminal provided at a photo studio or hospital.

FIG. 1A is a front perspective view of the imaging device according to the first embodiment. FIG. 1B is a back perspective view of the imaging device according to the first embodiment.

The imaging device 100 of FIG. 1A includes a lens unit 100a and a housing 100b. On the housing 100b, a release button 101 is arranged. The release button 101 is an operation member that receives an imaging operation from a user (photographer).

On the back surface of the housing 100b of FIG. 1B, an eyepiece lens 102 (viewfinder), which the user looks into to view a display device 214 (display panel) which is included in the housing 100b and will be described later, is arranged. On the back surface of the housing 100b, an operation member 103, an operation member 104, and an operation member 105, which receive various operations from the user, are arranged.

The operation member 103 is, for example, a touch panel that receives a touch operation of the user. The operation member 104 is an operation lever that can be pressed down in all directions. The operation member 105 is a four-way key that can be pressed in each of the four directions. The operation member 103 (touch panel) includes a display panel (e.g., a liquid crystal panel). The operation member 103 includes a function for displaying an image on the display panel.

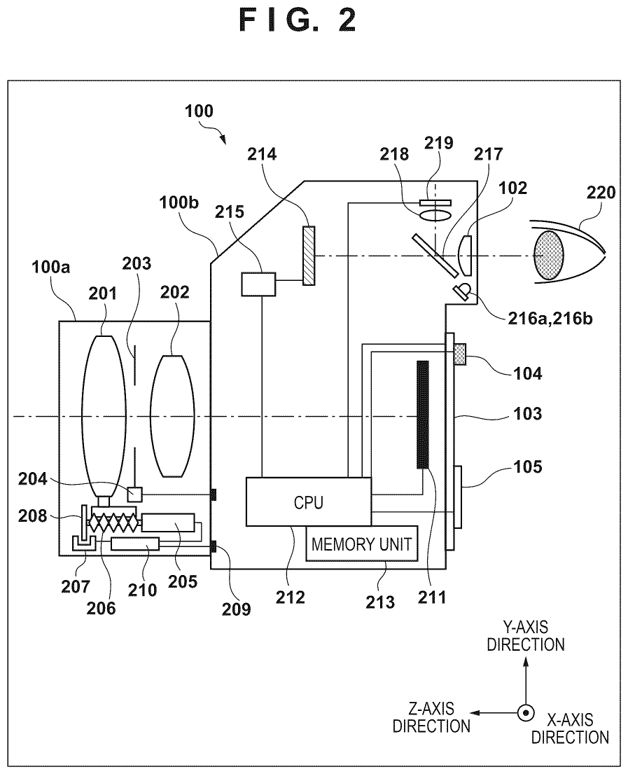

FIG. 2 is a sectional view of the imaging device taken along a YZ plane formed by a Y-axis and a Z-axis illustrated in FIG. 1A. FIG. 2 illustrates an overview of an internal configuration of the imaging device 100.

The lens unit 100a includes a lens 201, a lens 202, a diaphragm 203, a diaphragm driving unit 204, a lens driving motor 205, a lens driving member 206, a photocoupler 207, a pulse plate 208, a mount contact 209, and a focus adjustment circuit 210.

The lens driving member 206 includes a driving gear. The photocoupler 207 detects the rotation of the pulse plate 208, which is linked with the lens driving member 206, and transmits detected information to the focus adjustment circuit 210.

The focus adjustment circuit 210 drives the lens driving motor 205 based on information from the photocoupler 207 and information (lens driving amount information) from the housing 100b, and moves the lens 201 to change the focus position.

The mount contact 209 is an interface between the lens unit 100a and the housing 100b. For ease of explanation, two lenses (lens 201 and lens 202) have been illustrated, but in practice, two or more lenses are included in the lens unit 100a.

The housing 100b includes an imaging element 211, a CPU 212, a memory unit 213, the display device 214, and a display device driving circuit 215.

The imaging element 211 is arranged on a planned imaging surface of the lens unit 100a.

The CPU 212 is a central processing unit of a microcomputer and controls the entire imaging device 100.

The memory unit 213 stores various kinds of information. For example, the memory unit 213 stores an image captured by the imaging element 211.

The display device 214 displays various kinds of information on a screen of the display device 214. For example, the display device 214 is a liquid crystal panel, and displays a captured image (subject image) on the screen.

The display device driving circuit 215 drives the display device 214. The user can view the screen of the display device 214 through the eyepiece lens 102.

The housing 100b further includes a light source 216a, a light source 216b, a light splitter 217, a light receiving lens 218, and an eye imaging element 219.

The light source 216a and the light source 216b are light sources that are conventionally used in a single-lens reflex camera to detect the gaze from a relationship between a reflection image of light being reflected from the cornea (corneal reflection image) and the pupil. The light source 216a and the light source 216b are light sources for illuminating an eye 220 of the user looking through the viewfinder (eyepiece lens 102). For example, the light source 216a and the light source 216b are infrared light emitting diodes that emit infrared light, which is imperceptible to the user, and are arranged around the eyepiece lens 102. An optical image of the illuminated eye 220 (eye optical image; optical image from reflected light, which had been emitted from the light source 216a and the light source 216b and reflected by the eye 220) is transmitted through the eyepiece lens 102 and reflected by the light splitter 217. Then, the eye optical image is formed by the light receiving lens 218 on the eye imaging element 219 on which a plurality of photoelectric conversion elements has been arranged two dimensionally (e.g., a CCD or CMOS).

The light receiving lens 218 positions the pupil of the eye 220 and the eye imaging element 219 in a conjugate imaging relationship. The gaze of the eye 220 is detected from the position of a corneal reflection image in the eye optical image formed on the eye imaging element 219 by gaze detection processing, which will be described later. For example, as information related to the gaze, at least one of information indicating a gaze direction (direction of the gaze) and information indicating a viewpoint (position where the gaze is directed) on the screen of the display device 214 is obtained. The viewpoint is a position that the user is looking at or a gaze position.

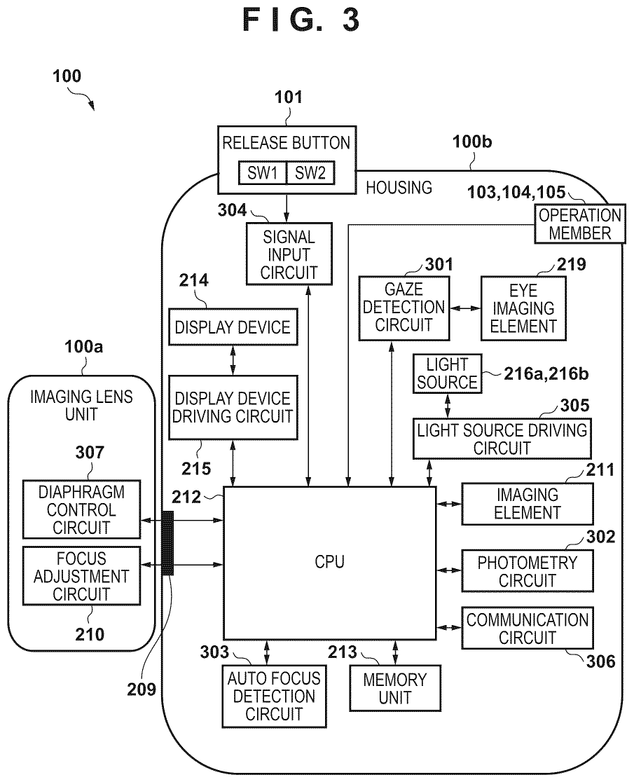

FIG. 3 is a block diagram illustrating an electrical configuration in the imaging device according to the first embodiment.

In the CPU 212, a gaze detection circuit 301, a photometry circuit 302, an auto focus detection circuit 303, a signal input circuit 304, the display device driving circuit 215, a light source driving circuit 305, and a communication circuit 306 are connected.

The CPU 212 transmits signals to the focus adjustment circuit 210, which is arranged in the lens unit 100a, and a diaphragm control circuit 307, which is included in the diaphragm driving unit 204 in the lens unit 100a, via the mount contact 209. The memory unit 213 that accompanies the CPU 212 includes a function for storing imaging signals from the imaging element 211 and the eye imaging element 219.

The gaze detection circuit 301 A/D-converts an output (eye image obtained by imaging the eye 220) of the eye imaging element 219 in a state in which an eye optical image is formed on the eye imaging element 219, and transmits the result to the CPU 212. The CPU 212 extracts a feature point necessary for gaze detection from the eye image according to gaze detection processing, and detects the gaze of the user from the position of the feature point.

The photometry circuit 302 performs predetermined processing (e.g., amplification, logarithmic compression, and A/D conversion) on a signal (e.g., a luminance signal corresponding to the brightness of the field) obtained from the imaging element 211, which also serves as a photometry sensor, and transmits the result to the CPU 212 as field luminance information.

The auto focus detection circuit 303 A/D-converts signals from a plurality of detection elements (plurality of pixels) included in the imaging element 211 and used for phase difference detection, and transmits the A/D-converted result to the CPU 212. The CPU 212 calculates, from the signals of the plurality of detection elements, distances to the subject that correspond to the respective focus detection points. This is a known technique known as imaging plane phase difference AF.

A switch SW1 and a switch SW2 are connected to the signal input circuit 304. The switch SW1 transmits an ON signal at a first stroke of the release button 101. The switch SW1 is a switch for starting an imaging preparation operation (e.g., photometry and ranging) of the imaging device 100. The switch SW2 transmits an ON signal at a second stroke of the release button 101. The switch SW2 is a switch for starting an imaging operation. The ON signals from the switch SW1 and the switch SW2 are inputted to the signal input circuit 304, and are transmitted to the CPU 212. When the switch SW1 is turned ON, gaze detection may be started.

The light source driving circuit 305 drives the light source 216a and the light source 216b.

The communication circuit 306 connects and communicates with an external device in accordance with communication standards such as Bluetooth and WiFi.

Furthermore, the operation member 103, the operation member 104, and the operation member 105 are connected to the CPU 212. When the user operates the operation member 103, the operation member 104, and the operation member 105, the operation member 103 to the operation member 105 output operation signals corresponding to the operation from the user to the CPU 212. The CPU 212 performs processing (control) according to an operation signal. For example, the CPU 212 moves a selection frame of a displayed menu in response to an operation signal.

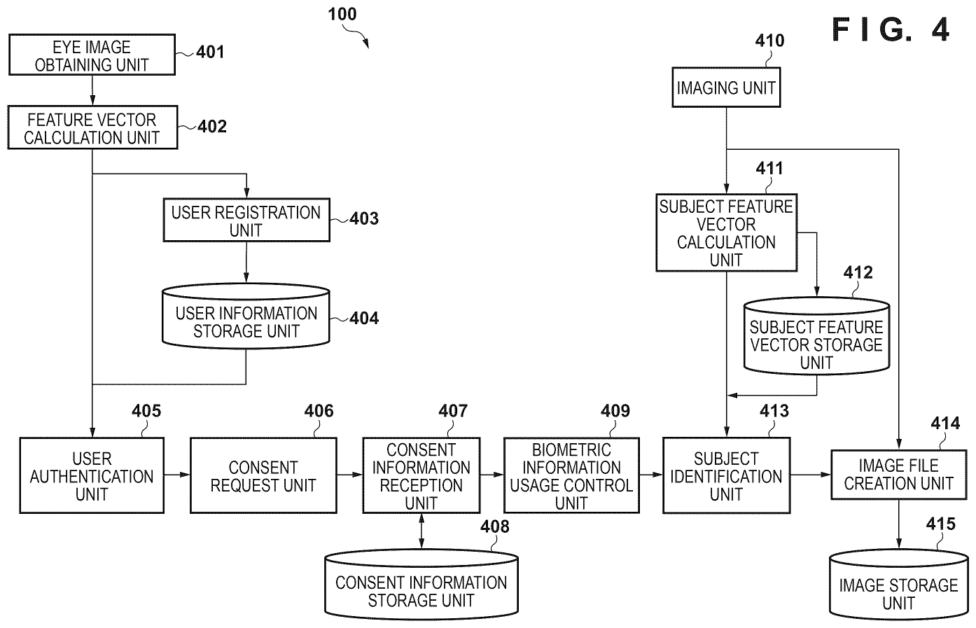

FIG. 4 is a view illustrating a functional configuration of the imaging device according to the first embodiment. The imaging device 100 is an imaging device capable of controlling the use of biometric information. The imaging device 100 uses an image of the eye 220 of the user looking through the viewfinder (eyepiece lens 102) to authenticate whether the user looking through the viewfinder is a registered user.

An eye image obtaining unit 401 obtains an image of the eye 220 of the user looking through the viewfinder (eyepiece lens 102).

A feature vector calculation unit 402 calculates a feature vector to be used for user authentication from the eye image.

A user registration unit 403 creates data (user registration information) to be registered to a user information storage unit 404.

The user information storage unit 404 is constituted by the memory unit 213 and stores registration information of the user who uses the imaging device 100.

A user authentication unit 405 authenticates whether the user (photographer) using the imaging device 100 is a user registered in the user information storage unit 404. The user authentication unit 405 is an authentication unit that authenticates a user. The user authentication unit 405 can perform authentication of the user based on an eye image obtained from the user.

A consent request unit 406 is an obtaining unit that obtains consent information, which consents to the use of biometric information of the subject. The consent request unit 406 transmits, to the portable terminal 500, which belongs to the subject, or a terminal other than the portable terminal 500, a request to transmit consent information, which consents to the use of biometric information of the subject. Then, the consent request unit 406 can obtain consent information from the portable terminal 500, which belongs to the subject, or a terminal other than the portable terminal 500.

A consent information management unit 407 manages authenticated user information and consent information, which consents to the use of biometric information of the subject and has been obtained from the portable terminal 500 of the subject, in association with each other.

A consent information storage unit 408 is constituted by the memory unit 213. The consent information storage unit 408 stores authenticated user information and consent information, which consents to the use of biometric information of the subject, in association with each other.

An imaging unit 410 stores an image captured by the imaging element 211 in the memory unit 213 when a signal of a press of the release button 101 by the user is received.

A subject feature vector calculation unit 411 calculates a feature vector of the subject imaged by the imaging unit 410.

A subject feature vector storage unit 412 stores the feature vector of the subject.

A subject identification unit 413 identifies the subject (e.g., the name of the subject) based on the feature vector of the subject registered in the subject feature vector storage unit 412 and the feature vector of the subject extracted from the captured image.

A biometric information usage control unit 409 is a control unit that controls the use of biometric information of the subject. The biometric information usage control unit 409 performs control that limits a function for using biometric information (e.g., a function of the subject identification unit 413) and the use of an image file creation unit 414 based on the subject consent information managed by the consent information management unit 407. For example, the biometric information usage control unit 409 performs control that limits storage, distribution, and display of biometric information based on the subject consent information. Further, the biometric information usage control unit 409 can control the use of biometric information based on an authentication result of the subject by a subject authentication unit 603, which will be described later, and consent information.

The image file creation unit 414 is an output unit that outputs an image file. An image file to which user information and consent information have been added as metadata of an image in which the subject is captured is created, and an image file is outputted.

An image storage unit 415 is constituted by the memory unit 213. The image storage unit 415 stores the image file to which user information and consent information have been added as metadata.

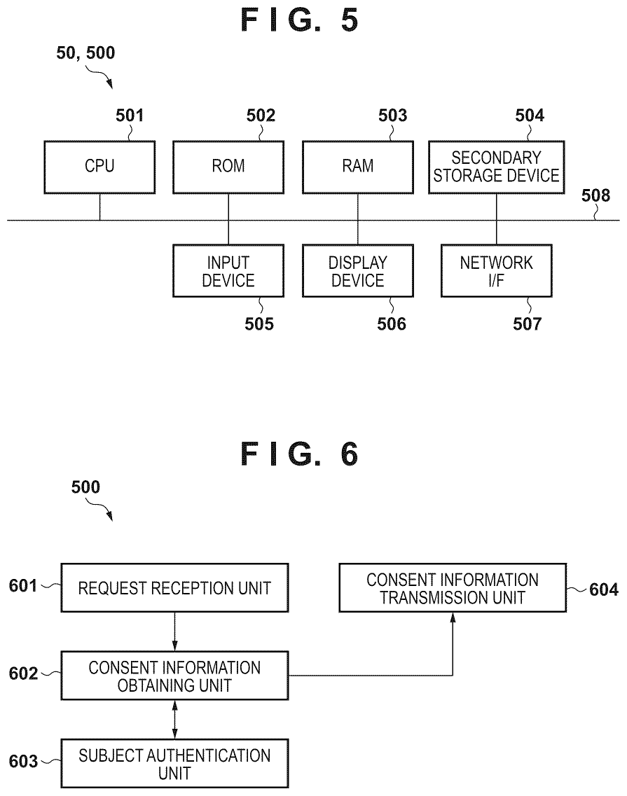

FIG. 5 is a block diagram illustrating a hardware configuration of the portable terminal according to the first embodiment. The portable terminal 500 includes a CPU 501, a ROM 502, a RAM 503, a secondary storage device 504, an input device 505, a display device 506, a network I/F 507, and a bus 508.

The CPU 501 executes instructions according to programs stored in the ROM 502 and the RAM 503. The CPU 501 reads out, from the secondary storage device 504 and the RAM 503, software in which processing corresponding to respective steps of flowcharts, which will be described later, are implemented, and executes the read result.

The ROM 502 is a non-volatile memory that stores a program that realizes each embodiment, programs necessary for other kinds of control, and data.

The RAM 503 is a volatile memory that stores temporary data, such as frame image data and pattern classification results.

The secondary storage device 504 is a rewritable secondary storage device, such as a hard disk drive and a flash memory. The secondary storage device 504 stores images, programs, and various settings. These kinds of stored information are transferred to the RAM 503. The CPU 501 executes programs of the RAM 503 and uses data.

The input device 505 is a device (input unit) that receives user input, and is, for example, a keyboard and a mouse.

The display device 506 is a device that displays a processing result to the user, and is, for example, one of a Braun tube CRT, a liquid crystal display, and an organic EL display.

The network I/F 507 is a modem and a LAN that connects to a network, such as the Internet and an intranet.

The bus 508 connects respective units of the portable terminal 500 with each other and performs input and output of data between the respective units.

FIG. 6 is a view illustrating a functional configuration of the portable terminal according to the first embodiment. The portable terminal 500 includes a request reception unit 601, a consent information obtaining unit 602, the subject authentication unit 603, and a consent information transmission unit 604.

The request reception unit 601 is constituted by the network I/F 507. The request reception unit 601 receives a request to transmit consent information, which consents to the use of biometric information, from the imaging device 100.

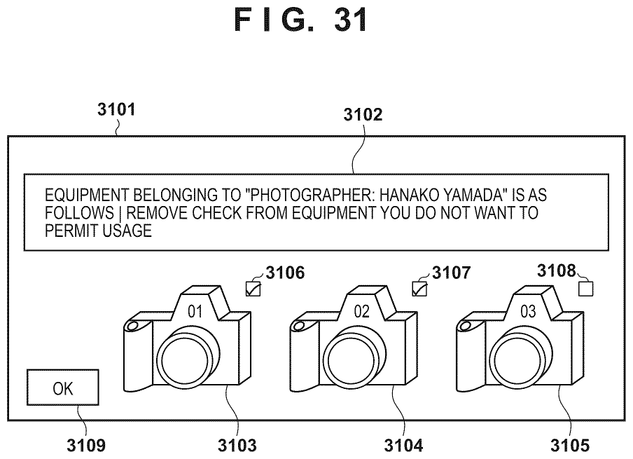

The consent information obtaining unit 602 includes the input device 505 and the display device 506. The consent information obtaining unit 602 is an obtaining unit that obtains consent information, which consents to the use of biometric information of the subject. The consent information obtaining unit 602 obtains consent information, which consents to the use of biometric information of the subject, based on input information inputted by the subject via the input device 505 (input unit). For example, the subject can input information of an imaging device to be granted consent to the use of biometric information via the input device 505 (input unit) from information of one or more imaging devices, as illustrated in FIG. 31. Then, the consent information obtaining unit 602 receives input of the input device 505.

The subject authentication unit 603 is a subject authentication unit that authenticates whether the subject is a subject registered in the portable terminal 500. The subject authentication unit 603 can authenticate the subject that uses the portable terminal 500 using biometric authentication, such as face authentication, fingerprint authentication, and iris authentication, for example.

The consent information transmission unit 604 is constituted by the network I/F 507 and the like. The consent information transmission unit 604 is a transmission unit that transmits consent information to the imaging device. The consent information transmission unit 604 transmits consent information, which consents to the use of biometric information obtained by the consent information obtaining unit 602, to the imaging device 100.

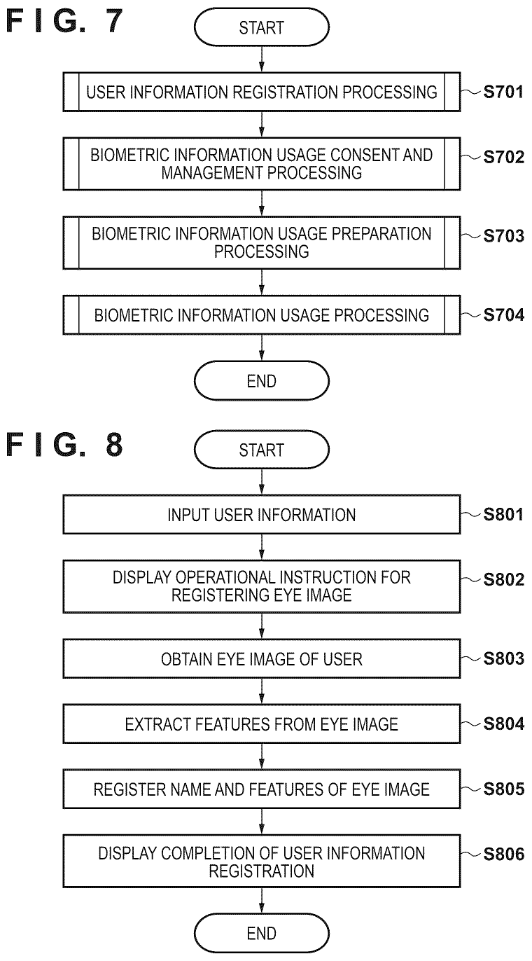

FIG. 7 is a flowchart for explaining processing to be executed by the imaging system according to the first embodiment. The imaging system controls the use of biometric information of the subject.

Step S701 is user information registration processing. In step S701, the imaging device 100 registers user information in order to perform user authentication.

Step S702 is biometric information usage consent and management processing. In step S702, the portable terminal 500 obtains consent information, which consents to the use of biometric information from the subject. Meanwhile, the imaging device 100 associates the user information registered in step S701 and consent information, which consent to use of biometric information obtained from the portable terminal 500, with each other.

Step S703 is biometric information usage preparation processing. In step S703, before starting capturing of an image of the subject, the imaging device 100 performs preparations (settings) for allowing the use of biometric information of the subject.

Step S704 is biometric information usage processing. In step S704, the imaging device 100 uses the biometric information of the subject.

FIG. 8 is a flowchart for explaining processing to be executed by the imaging device in step S701 of FIG. 7.

Before the user (photographer) images the subject with the imaging device 100, the user operates the imaging device 100 to perform user registration. When the user calls the user registration processing by operating a menu screen (not illustrated) of the imaging device 100, the user registration processing is executed. For example, the menu screen is displayed on the touch panel (operation member 103) of the imaging device 100. The user operates the menu screen using the operation member 103 to the operation member 105 to select a menu that calls the user registration processing. When the menu is selected by the user, the user registration processing is executed.

In step S801, the user inputs user information to the imaging device 100. In the present embodiment, the user inputs a “name”. For example, a screen (not illustrated) for inputting a name to the touch panel (operation member 103) is displayed. The user operates the operation members 103 to 105 to input a name. After inputting a name, the user presses a complete button displayed on the screen, and name input is thereby completed.

In step S802, the imaging device 100 displays an operational instruction for registering an eye image of the user.

The imaging device 100, for example, displays the operational instruction for the user on the touch panel (operation member 103). The operational instruction for the user is an instruction for the user to look through the viewfinder (eyepiece lens 102). At this time, the imaging device 100 may display the operational instruction on the touch panel (operation member 103) including that the user does not blink, opens their eye wide, and the like such that a good eye image of the user can be captured.

In step S803, the imaging device 100 captures an image while the user is looking through the viewfinder (eyepiece lens 102) and obtains an eye image of the user. The imaging device 100, for example, obtains an eye image (eye image signal; electrical signal of the eye image) of the user from the eye imaging element 219 through the gaze detection circuit 301. The imaging device 100 calculates a pupil center from a gaze detection result of the gaze detection circuit 301 and obtains an eye image in which the pupil center is positioned at the center of the image.

In step S804, the feature vector calculation unit 402 calculates a feature vector from the eye image. The feature vector calculation unit 402, for example, uses a neural network as a feature extractor in order to calculate a feature vector from the eye image. The neural network is, for example, a Convolutional Neural Network (hereinafter, CNN). The CNN repeatedly performs processing constituted by convolution processing, activation processing, and pooling processing a number of times on an input image. This allows the CNN to extract abstracted information from the input image. Here, a unit of processing constituted by convolution processing, activation processing, and pooling processing is generally referred to as a hierarchy. The activation processing may be executed using a known method, and for example, may be executed using a method called Rectified Linear Unit (ReLU). Further, the pooling processing may be executed using a known method, and for example, may be executed using a method called Max Pooling. For example, the structure of the CNN may be constituted by a ResNet described in Non-Patent Document 1 (K. He, X. Zhang, S. Ren, and J. Sun. Identity mappings in deep residual networks. In ECCV, 2016.).

Further, the neural network may also be a neural network called a Vision Transformer (ViT) of Non-Patent Document 2 (Alexey Dosovitskiy, et al. An image is worth 16×16 words: Transformers for image recognition at scale. In ICLR, 2021.). The structure of the neural network is not limited thereto. The memory unit 213 holds information of the structure and weights of the neural network.

Further, it is assumed that the weights of the neural network have been obtained in advance by training the neural network. The neural network is trained using, for example, various human eye images for training obtained in advance and an ArcFace method of Non-Patent Document 3 (J. Deng, J. Guo, N. Xue, and S. Zafeiriou. Arcface: Additive angular margin loss for deep face recognition. In CVPR, 2019.).

Although a method in which a neural network is used has been given as an example of a method of user authentication in which an eye image is used, for example, known iris authentication (see Japanese Patent No. 3307936) may be used as the method of user authentication. The method of user authentication is not limited thereto.

In step S805, the imaging device 100 stores information in which the feature vector of the eye image of the user and the name of the user are associated with each other in the memory unit 213.

In step S806, the imaging device displays a screen that notifies the user of completion of user information registration on the touch panel (operation member 103) and/or the display device 214. The imaging device 100, for example, displays a message of “user information registration has been completed!” on the operation member 103. This allows the user to recognize that the operation for registering user information has been completed.

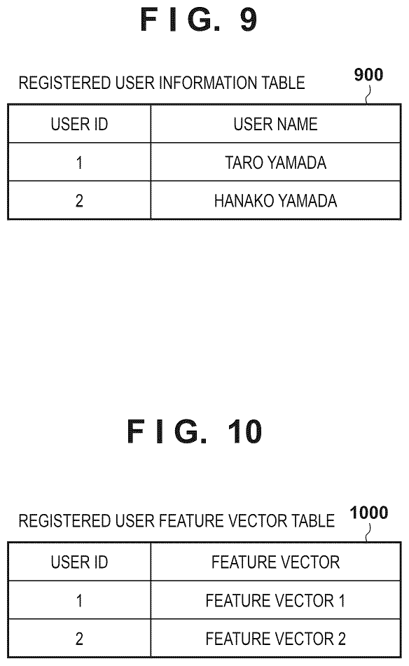

FIG. 9 illustrates an example of a registered user information table according to the first embodiment. FIG. 10 illustrates an example of a registered user feature vector table according to the first embodiment. The name of the user obtained by the imaging device 100 in step S801 is stored in the user name of a registered user information table 900 in FIG. 9. The registered user information table 900 may be referred to simply as “user information”. The feature vector extracted from the eye image of the user by the imaging device 100 in step S804 is stored in the feature vector of a registered user feature vector table 1000 of FIG. 10.

The registered user information table 900 and the registered user feature vector table 1000 have the same, shared user ID (i.e., “user ID: 1” and “user ID: 2”). The information of user names (Taro Yamada and Hanako Yamada) is stored in the registered user information table 900. In the registered user feature vector table 1000, feature vectors (feature vector 1 and feature vector 2) to be used by the user authentication unit 405 are stored.

### Processing for Obtaining and Managing Consent Information That Consents to Use of Biometric Information

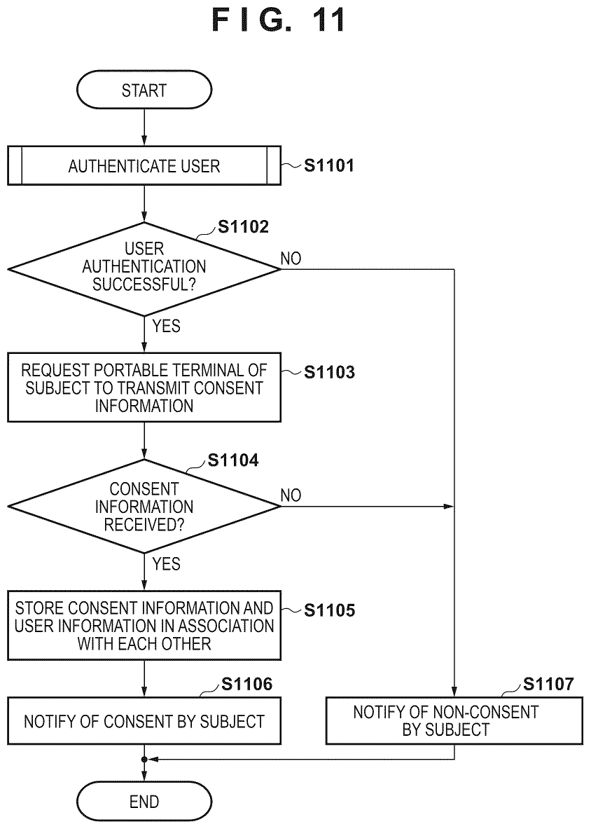

FIG. 11 is a flowchart for explaining processing to be executed by the imaging device in step S702 of FIG. 7. After the processing of step S1103 is executed, the portable terminal 500 executes the processing of FIG. 13.

Then, after the processing of FIG. 13 is completed, the processing of step S1104 of FIG. 11 is resumed.

In step S1101, the user authentication unit 405 performs the user authentication processing.

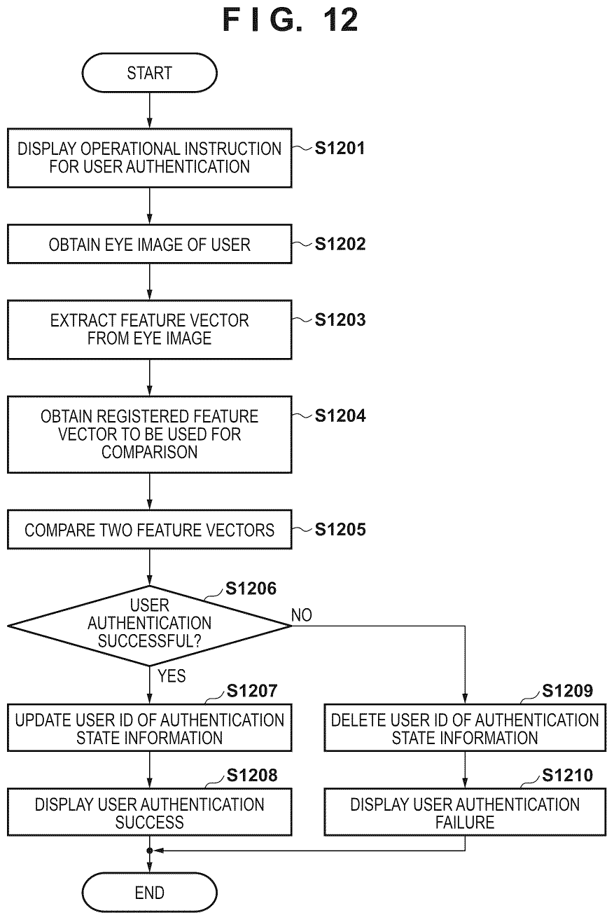

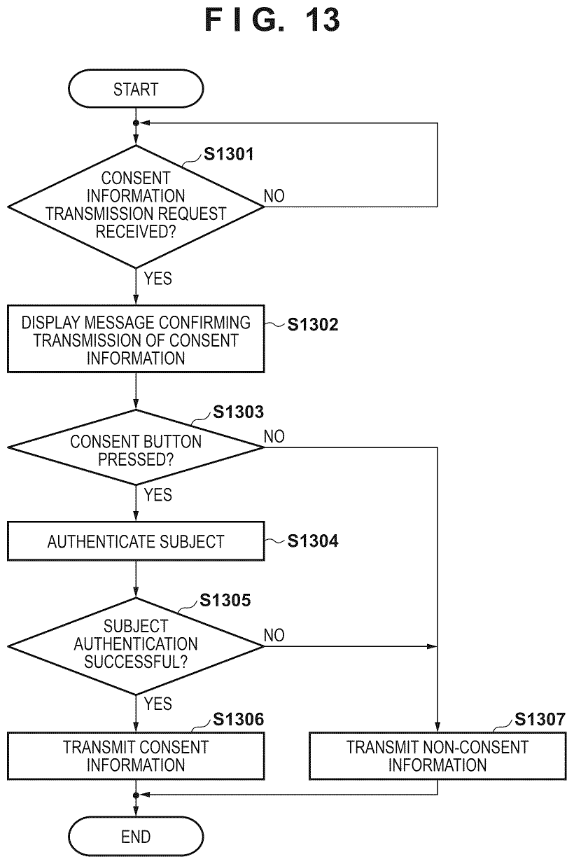

FIG. 12 is a flowchart for explaining user authentication processing to be executed by the imaging device according to the first embodiment.

The user authentication processing is executed when the user operates the imaging device 100 to call the user authentication processing from a menu screen. For example, a menu screen (not illustrated) is displayed on the touch panel (operation member 103) of the imaging device 100. Then, the user operates the menu screen using the operation member 103 to the operation member 105 to select a menu that calls the user authentication processing. This starts the user authentication processing.

In step S1201, the imaging device 100 displays an operational instruction for user authentication on a screen. The imaging device 100, for example, displays an operational instruction for the user to look through the viewfinder (eyepiece lens 102) on the touch panel (operation member 103). The operational instruction for user authentication may be an instruction that include, for example, not blinking, opening the eye wide, and holding the imaging device 100 securely, such that a good eye image of the user can be captured by the imaging device 100.

In step S1202, the imaging device 100 captures an eye image of the user while the user is looking through the viewfinder (eyepiece lens 102). Since the method of capturing an eye image of the user is similar to the method in step S803, description will be omitted.

In step S1203, the imaging device 100 calculates a feature vector from the eye image of the user captured in step S1202.

In step S1204, the imaging device 100 obtains a registered feature vector to be used for user authentication from the user information storage unit 404. The imaging device 100 obtains all the feature vectors (feature vector 1 and feature vector 2) of the registered user feature vector table 1000 of FIG. 10.

In step S1205, the imaging device 100 compares the feature vector of the eye image obtained in step S1203 and the registered feature vector obtained in step S1204 and thereby calculates a cos similarity. The imaging device 100 determines a user ID based on whether the calculated cos similarity exceeds a predetermined threshold. If the cos similarity exceeds the threshold, the imaging device 100 identifies a user ID (“user ID: 1” or “user ID: 2”) that corresponds to the registered feature vector (feature vector 1 or feature vector 2) used in the calculation of cos similarity. If the cos similarity does not exceed the threshold, the imaging device 100 does not determine a user ID.

In step S1206, it is determined whether user authentication has been successful. For example, if the cos similarity exceeds the threshold in step S1205 and there is a registered feature vector that has been used for calculation of the cos similarity, it is determined that user authentication has been successful. If it is determined that user authentication has been successful (YES in step S1206), the processing proceeds to step S1207. If it is determined that user authentication has not been successful (NO in step S1206), the processing proceeds to step S1209.

In step S1207, the imaging device 100 updates authentication state information to be stored in the memory unit 213 with the user ID identified in step S1205. The authentication state information refers to a currently authenticated user ID.

In step S1208, the imaging device 100 displays a screen that notifies the user of user authentication success on the touch panel (operation member 103) and/or the display device 214.

In step S1209, the imaging device 100 deletes the user ID of the authentication state information. The imaging device 100, for example, overwrites the authentication state information with a NULL value, which is a value indicating that it is empty.

In step S1210, the imaging device 100 displays a screen that notifies the user of user authentication failure on the touch panel (operation member 103) and/or the display device 214. Here, the description of FIG. 11 is returned to.

In step S1102, the imaging device 100 determines whether user authentication has been successful. If it is determined that user authentication has been successful (YES in step S1102), the imaging device 100 advances the processing to step S1103. Meanwhile, if it is determined that user authentication has been unsuccessful (NO in step S1102), the imaging device 100 advances the processing to step S1107.

In step S1103, the consent request unit 406 of the imaging device 100 requests the portable terminal 500, which belongs to the subject, to transmit consent information, which consents to the use of biometric information, in order to obtain consent information, which consents to the use of biometric information, from the subject.

FIG. 13 is a flowchart for explaining processing to be executed by the portable terminal according to the first embodiment. A processing program for FIG. 13 is downloaded to the portable terminal 500 from a predetermined web site in advance. That is, it is assumed that the processing program is provided in a form of an application that operates on the portable terminal 500.

In step S1301, the request reception unit 601 of the portable terminal 500 determines whether a consent information transmission request has been received from the imaging device 100. A consent information transmission request includes a predetermined code indicating a consent information transmission request and information of the user (name of the user) authenticated in step S1101. If it is determined that a consent information transmission request has been received from the imaging device 100 (YES in step S1301), the request reception unit 601 advances the processing to step S1302. If it is determined that a consent information transmission request has not been received from the imaging device 100 (NO in step S1301), the request reception unit 601 waits until a consent information transmission request is received from the imaging device 100.

In step S1302, the consent information obtaining unit 602 displays a confirmation message for confirming whether the subject consents to transmission of consent information on the screen of the portable terminal 500.

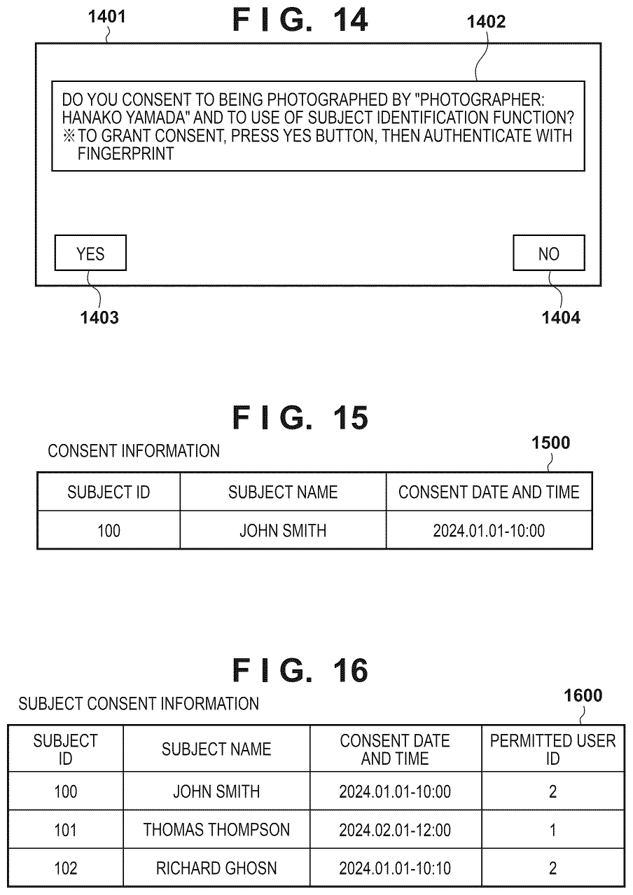

FIG. 14 illustrates an example of a confirmation message to be displayed on the portable terminal according to the first embodiment.

A confirmation message 1402 is displayed on a screen 1401. The confirmation message 1402 is a message indicating details of a consent information transmission request. A template based on a name (“Hanako Yamada”, who is the photographer), which is information of the authenticated user, and the name of a biometric information usage function to be used by the photographer (“subject identification function”) is displayed on the screen 1401. The template of FIG. 14 is, for example, “Do you consent to being photographed by ‘photographer: (user name)’ and to use of (biometric information usage function)?”. In FIG. 14, “(user name)” is Hanako Yamada, but is not limited thereto, and may be the name of another photographer. Further, on the screen 1401, a message “※ To grant consent, press yes button, then authenticate with fingerprint” is displayed. The purpose of displaying a message prompting the subject to authenticate with fingerprint is to confirm that the subject is the person by using a biometric authentication function (fingerprint authentication in the present embodiment) included in the portable terminal 500. This can avoid acts of infringing the privacy of the subject by malicious third parties disguising themselves as the subject. A YES button 1403 is a button for determining that the subject consents to the consent information transmission request. A NO button 1404 is a button for determining that the subject does not consent to the consent information transmission request. Here, the description of FIG. 13 is returned to.

In step S1303, the consent information obtaining unit 602 determines whether the subject has pressed the YES button 1403 by a touch operation or the like. If it is determined that the YES button 1403 has been pressed (YES in step S1303), the consent information obtaining unit 602 advances the processing to step S1304. A press of the YES button 1403 means that the subject has indicated an intent to consent to the use of biometric information. Meanwhile, if it is determined that the YES button 1403 has not been pressed (NO in step S1303), the consent information obtaining unit 602 advances the processing to step S1307. A press of the NO button 1404 means that the subject has indicated an intent to not consent to the use of biometric information.

In step S1304, in order to confirm that the instruction of step S1303 is an instruction by the subject themself, the subject authentication unit 603 authenticates the subject using the biometric authentication function (i.e., fingerprint authentication) included in the portable terminal 500. In step S1304, the subject authentication unit 603 may execute processing similar to user authentication (FIG. 12) by the user authentication unit 405.

In step S1305, the portable terminal 500 determines whether subject authentication has been successful. If it is determined that subject authentication has been successful (YES in step S1305), the portable terminal 500 advances the processing to step S1306. If it is determined that subject authentication has been unsuccessful (NO in step S1305), the portable terminal 500 advances the processing to step S1307.

In step S1306, the consent information transmission unit 604 transmits consent information 1500, which will be described later, to the imaging device 100.

In step S1307, the consent information transmission unit 604 transmits non-consent information (not illustrated) to the imaging device 100.

FIG. 15 illustrates an example of consent information according to the first embodiment.

The consent information 1500 includes a subject ID, a subject name, and a consent date and time. The subject ID is a combination of an ID issued for the subject in the portable terminal 500 of the subject and an individual number (telephone number, IP address, etc.) of the portable terminal 500.

The subject name is the name (e.g., John Smith) of a subject registered in advance in the portable terminal 500. The consent date and time is a date and time at which the subject indicated an intent to consent to the use of biometric information (e.g., a date and time when YES button 1403 was pressed). If the subject has not consented to the use of biometric information (when the NO button 1404 is pressed), the portable terminal 500 nullifies the consent information 1500 by storing NULL values in the subject ID, the subject name, and the consent date and time. The information obtained by thus nullifying the consent information 1500 will be referred to as “non-consent information”. Here, the description of FIG. 11 is returned to.

In step S1104, the consent request unit 406 determines whether consent information (see FIG. 15) has been received from the portable terminal 500. If it is determined that consent information has been received from the portable terminal 500 (YES in step S1104), the consent request unit 406 advances the processing to step S1105. Meanwhile, if it is determined that consent information has not been received from the portable terminal 500 (i.e., non-consent information has been received) (NO in step S1104), the consent request unit 406 advances the processing to step S1105.

In step S1105, the consent information management unit 407 stores subject consent information 1600 (see FIG. 16), in which consent information and user information are associated with each other and which will be described later, in the consent information storage unit 408.

FIG. 16 illustrates an example of subject consent information according to the first embodiment.

The subject consent information 1600 includes the consent information 1500 (subject ID, subject name, and consent date and time) received from the portable terminal 500 and the ID of a permitted user (i.e., the ID of a photographer) to whom the subject has granted consent to use biometric information. Thus, the presence or absence of subject consent (TRUE) indicates the presence or absence of consent to the current user. The subject consent information 1600 may include the consent information 1500 and the permitted user ID, as well as information of the imaging device to which the subject has granted consent to use biometric information (e.g., the model name, the individual number, and information of an imaging device that supports image authenticity assurance). Alternatively, the subject consent information 1600 may include the consent information 1500 and information of the imaging device to which the subject has granted consent to use biometric information (e.g., the model name, the individual number, and information of an imaging device that supports image authenticity assurance). Thus, a target (also referred to as a specific target) to which the subject grants consent to use biometric information may include only the user, both the user and the imaging device, and only the imaging device.

The imaging device 100 may obtain the consent information 1500 from a plurality of subjects. In FIG. 16, each of two subjects (subject ID=100 and 102) has consented to the use of biometric information by the permitted user ID=2.

In step S1106, the imaging device 100 displays a screen that notifies the user that the subject has consented to the use of biometric information on the display touch panel (operation member 103) and/or the display device 214. For example, the imaging device 100 can display a message “Consent of the subject has been obtained!” on the screen.

In step S1107, the imaging device 100 displays a screen that notifies the user that the subject has not consented to the use of biometric information on the touch panel (operation member 103) and/or the display device 214. For example, the imaging device 100 can display a message “Consent of the subject has not been obtained.” on the screen.

### Biometric Information Usage Preparation Processing

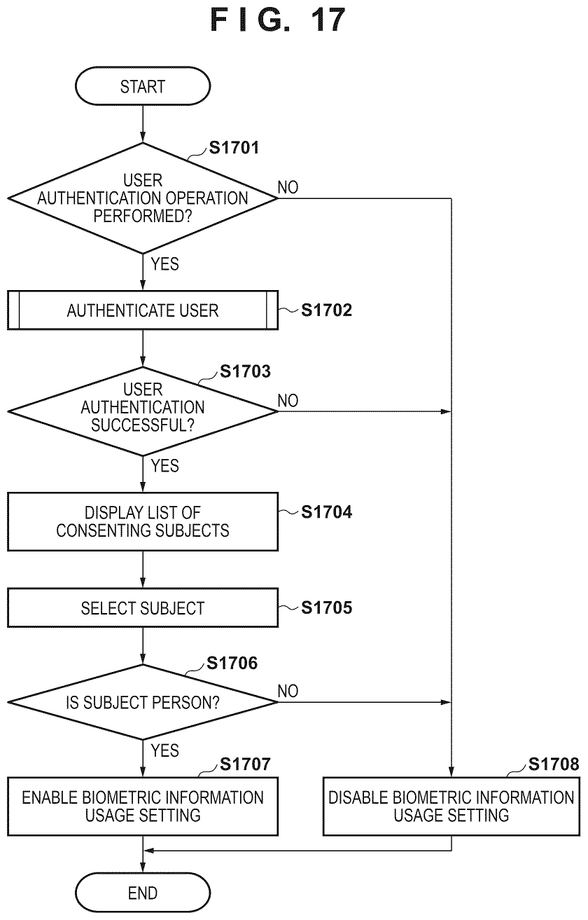

FIG. 17 is a flowchart for explaining processing to be executed by the imaging device in step S703 of FIG. 7.

In step S1701, the imaging device 100 determines whether the user has called the user authentication processing from a menu by operating the imaging device 100. Since a method of calling the user authentication processing is similar to the method of calling the user information registration processing, detailed description will be omitted. If it is determined that the user authentication processing has been called (YES in step S1701), the imaging device 100 advances the processing to step S1702. Meanwhile, if it is determined that the user authentication processing has not been called (NO in step S1701), the imaging device 100 advances the processing to step S1708.

In step S1702, the user authentication unit 405 performs the user authentication processing. Since details of the user authentication processing are the same as those of the description in FIG. 12, description will be omitted.

In step S1703, if it is determined that user authentication of step S1702 has been successful (YES in step S1703), the imaging device 100 advances the processing to step S1704. If it is determined that user authentication of step S1702 has not been successful (NO in step S1703), the imaging device 100 advances the processing to step S1708.

In step S1704, the imaging device 100 displays a list of subjects that has consented to the use of biometric information. The consent information management unit 407 creates a list of subjects by reading out the subject consent information 1600 from the consent information storage unit 408. If the permitted user ID of the subject consent information 1600=2 (see FIG. 16), the imaging device 100 displays “John Smith” and “Richard Ghosn” in a list on the touch panel (operation member 103) and/or the display device 214.

In step S1705, the imaging device 100 receives the input of the subject selected by the user. For example, the user selects a subject to be imaged from the list of subjects by a touch operation or the like.

In step S1706, the imaging device 100 determines whether the subject selected by the user from the list of subjects is the same as the subject about to be imaged. For example, similarly to the method of obtaining the consent information 1500, the imaging device 100 transmits a request to execute biometric authentication of the subject to the portable terminal 500 of the subject. Then, the subject uses the biometric authentication function (here, fingerprint authentication) of the portable terminal 500. The imaging device 100 can determine whether the subject selected by the user is the same as the subject about to be imaged based on the fingerprint authentication result received from the portable terminal 500. Alternatively, the imaging device 100 may confirm the identity of the subject by transmitting the subject ID of the subject consent information 1600 (subject ID issued by the portable terminal 500) to the portable terminal 500 of the subject to be confirmed. Then, the portable terminal 500 may verify whether the subject ID received from the imaging device 100 and the subject ID held by the portable terminal 500 match. The imaging device 100 may confirm the identity of the subject based on the verification result of the subject ID received from the portable terminal 500.

If it is determined that the subject selected from the list of subjects by the user and the subject about to be imaged by the user are the same (YES in step S1706), the imaging device 100 advances the processing to step S1707. If it is determined that the subject selected from the list of subjects by the user and the subject about to be imaged by the user are not the same (NO in step S1706), the imaging device 100 advances the processing to step S1708.

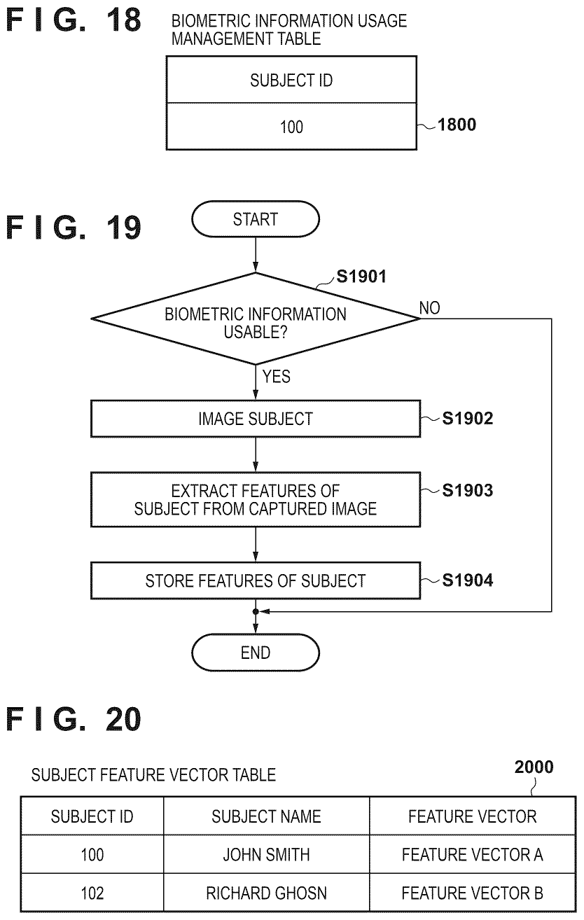

In step S1707, the biometric information usage control unit 409 registers the subject ID in a table 1800 (see FIG. 18), which will be described later, such that the imaging device 100 can use the biometric information of the subject.

This enables the biometric information usage function of the imaging device 100.

Here, FIG. 18 illustrates an example of a biometric information usage management table according to the first embodiment.

The table 1800 (biometric information usage management table) indicates the ID of a subject whose biometric information can be used. The memory unit 213 holds the table 1800. In FIG. 18, only the subject ID=100 is selected. Further, in step S1706, it is assumed that the confirmation of identity of the subject corresponding to the subject ID=100 has been successful.

In step S1708, the biometric information usage control unit 409 sets predetermined information in the table 1800 such that the imaging device 100 cannot use the biometric information of the subject. The biometric information usage control unit 409, for example, sets a NULL value to the subject ID of the table 1800, and thereby disables the biometric information usage function of the imaging device 100.

### Biometric Information Usage Processing

FIG. 19 is a flowchart for explaining processing to be executed by the imaging device in step S704 of FIG. 7. First, processing for the imaging device 100 to extract a feature vector, which is one kind of biometric information, will be described with reference to FIG. 19.

In step S1901, the imaging device 100 determines whether there is an ID of a subject whose biometric information can be used in the table 1800. If it is determined there is an ID of a subject whose biometric information can be used in the table 1800 (YES in step S1901), the imaging device 100 advances the processing to step S1902. Meanwhile, if it is determined there is no ID of a subject whose biometric information can be used in the table 1800 (NO in step S1901), the imaging device 100 ends the processing.

In step S1902, the imaging unit 410 images the subject.

In step S1903, the subject feature vector calculation unit 411 extracts a feature vector of the subject from the captured image obtained by imaging the subject. The subject feature vector calculation unit 411 extracts features of the face of the subject from the captured image, but may extract features such as the upper body and the whole body of the subject from the captured image. As a method of extracting features of a subject from a captured image, there is a method in which a CNN is used, similarly to that of the feature vector calculation unit 402.

In step S1904, the imaging device 100 stores, in the subject feature vector storage unit 412, a subject feature vector table 2000 (see FIG. 20) in which a feature vector extracted from the captured image by the subject feature vector calculation unit 411 and the consent information 1500 (subject ID and subject name), which has been received from the portable terminal 500, are associated with each other.

FIG. 20 illustrates an example of the subject feature vector table according to the first embodiment. The subject feature vector table 2000 includes a subject ID, a subject name, and a feature vector. The subject ID includes, for example, 100 and 102. Subject names include, for example, John Smith and Richard Ghosn. The feature vector includes, for example, a feature vector A and a feature vector B. The feature vector is a feature vector of the subject that has been extracted from the captured image by the subject feature vector calculation unit 411 in step S1903.

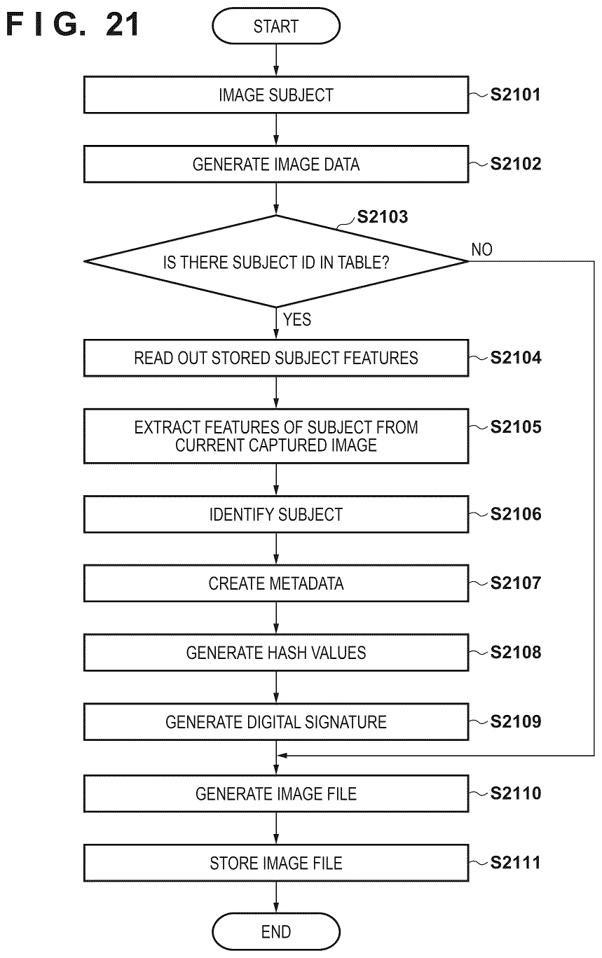

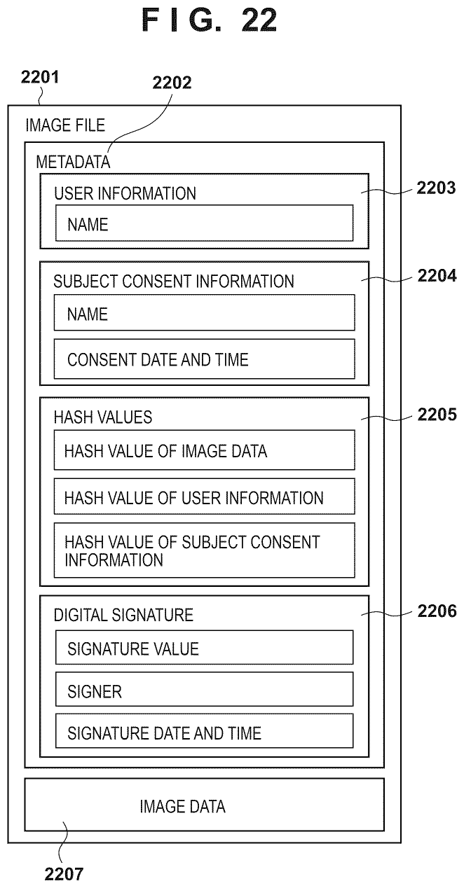

FIG. 21 is a flowchart for explaining processing to be executed by the imaging device in step S704 of FIG. 7. FIG. 22 illustrates an example of a file format of a captured image according to the first embodiment.

The processing of FIG. 21 is executed when the release button 101 is pressed to the second stroke. The processing of FIG. 21 will be described with reference to FIG. 22.

In step S2101, the imaging unit 410 images the subject. For example, imaging processing for converting light received by the imaging element 211 into an electrical signal is performed.

In step S2102, the imaging unit 410 generates image data. For example, the imaging unit 410 performs image processing such as developing processing and encoding processing on the electrical signal obtained by imaging processing of step S2101 to generate image data 2207 of FIG. 22.

In step S2103, the imaging device 100 determines whether there is an ID of a subject whose biometric information can be used in the table 1800. If it is determined there is an ID of a subject whose biometric information can be used in the table 1800 (YES in step S2103), the imaging device 100 advances the processing to step S2104. If it is determined there is no ID of a subject whose biometric information can be used in the table 1800 (NO in step S2103), the imaging device 100 advances the processing to step S2110.

In step S2104, the subject identification unit 413 reads out the current subject ID and subject feature vectors from the subject feature vector storage unit 412. The subject identification unit 413 references the subject feature vector table 2000.

In step S2105, the subject feature vector calculation unit 411 calculates a feature vector of the subject from the image data 2207. Since the processing for calculating a feature vector of a subject is similar to the processing of step S804, description will be omitted.

In step S2106, the subject identification unit 413 compares the subject feature vector (feature vector A and feature vector B) read out in step S2104 with the feature vector of the subject extracted in step S2105, and thereby identifies the subject. The subject identification processing may be executed using a cos similarity, similar to the processing of step S1205. If the cos similarity exceeds a threshold, the subject identification unit 413 identifies a subject ID and a subject name that corresponds to the feature vector (feature vector A or feature vector B) used in the calculation of the cos similarity. This allows the imaging device 100 to display the subject name of the subject captured in the captured image (image data 2207).

In step S2107, the imaging device 100 creates metadata based on the table 1800 and the subject consent information 1600. The metadata includes the subject name, the consent date and time, and the user name, which is associated with the permitted user ID and has been obtained from the registered user information table 900. This makes it possible to indicate which subject has granted consent to which user, and when, for the image to be captured.

As a method of storing metadata of an image, there is a method known as C2PA described in Non-Patent Document 4 (Coalition for Content Provenance and Authenticity (C2PA), “C2PA Specifications”, Technical Specifications Version 1.2, [online], Nov. 3, 2022, [Search on Jan. 23, 2023], and Internet URL: https://c2pa.org/specifications/specifications/1.2/specs/C2PA_Specification.html). C2PA is a method of attaching metadata to an image indicating details of edits executed on the image in order to authenticate the source, background, and provenance of the image. Therefore, the imaging device 100 may store the authentication state based on C2PA, but is not limited thereto, and may store the authentication state using another method. Alternatively, the imaging device 100 may store the image file and the metadata file separately. Furthermore, the imaging device 100 may manage the metadata in a database. The method of storing metadata is not limited thereto.

In step S2108, the image file creation unit 414 executes a hash function on binary data of each of the image data 2207, user information 2203, and subject consent information 2204 of FIG. 22 to generate hash values 2205.

In step S2109, the image file creation unit 414 generates a digital signature 2206. The digital signature 2206 includes information indicating a signature value, a signer, and a signature date and time. The signature value is generated by encrypting the hash values 2205 generated in step S2108 using a private key prepared in advance. A public key that forms a pair with the private key used here is also stored in the digital signature 2206. In the signer according to the present embodiment, information indicating the manufacturer of the imaging device 100 is stored. In the signer, the model name of the imaging device 100 may be stored instead of the manufacturer of the imaging device 100. Further, in the signature date and time, a date and time when digital signature generation has been completed is stored.

In step S2110, the image file creation unit 414 generates an image file 2201 by adding the user information 2203, the hash values 2205, and the digital signature 2206 as the metadata 2202 to the image data 2207. Here, when the image data 2207 is a still image, the image file creation unit 414 generates the image file 2201 based on a JPEG format. When the image data 2207 is a moving image, the image file creation unit 414 generates the image file 2201 based on an MPEG format.

In step S2109, the image file creation unit 414 stores the image file 2201 in the memory unit 213. The memory unit 213 may be a storage medium capable of being attached to and detached from the imaging device 100. The image file 2201 may be stored in the memory unit 213, which is a storage medium.

A verification method, which will be described below, is used to confirm that the image file 2201 has not been tampered with. First, the imaging device 100 restores the hash value with the public key based on the signature value. Furthermore, the imaging device 100 recalculates the hash values of the image data 2207 and the user information 2203. If the restored hash values match the recalculated hash values, the imaging device 100 can determine that the image data 2207 has not been tampered with. Meanwhile, if the restored hash values do not match the recalculated hash values, the imaging device 100 can determine that the image data 2207 has been tampered with.

If a person has tampered with the image data 2207, since the signature value is encrypted by the private key, the person who tampered with the image data 2207 cannot change the signature value. Therefore, if the image data 2207 has been tampered with, the hash value obtained from the image data 2207 and the restored hash value will not match. Thus, the imaging device 100 can detect the tampering of the image data 2207.

In the present embodiment, the hash values are included in the image file 2201. However, the imaging device 100 can recalculate the hash values from the image data 2207 and the user information 2203 included in the image file 2201. Therefore, the hash value need not be included in the image file 2201.

When the imaging device 100 captures a moving image of the subject, moving image capturing is started after the release button 101 is pressed to the second stroke. The moving image capturing is completed when the release button 101 is pressed again to the second stroke. Then, moving image data is generated by executing the processing of steps S2101 and S2102. The imaging device 100 can calculate a hash value of the moving image data and store the hash value of the moving image data instead of the hash value of the image data. In this case, the imaging device 100 stores a moving image file in which the moving image data and metadata are associated with each other.

As described above, the imaging device 100 can display the subject name, the consent date and time, and the user name as character strings on the image data 2207. Therefore, the user and/or the subject can confirm that the biometric information of the subject is obtained and used according to a correct procedure.

In step S2110 (step S2110 that is executed when step S2103 is NO), the image file creation unit 414 stores the image file 2201, in which there is no metadata 2202, in the memory unit. Here, even if the image file 2201 in which there is no metadata 2202 is read, the person name will not be displayed. If there is no ID of a subject whose biometric information can be used, the imaging device 100 may execute processing in which the image file 2201 cannot be stored and processing in which the image file 2201 cannot be transmitted to other devices. The present disclosure is not limited to such processing, and any method may be applied so long as it is within a scope in which control that does not allow the use of biometric information of the subject is realized.

As described above, according to the first embodiment, the subject can allow a specific target to use the biometric information of the subject. The specific target according to the first embodiment is a user (photographer) who uses the imaging device 100, but the present disclosure is not limited thereto, and may be both the user and the imaging device 100, or only the imaging device 100.

### Second Embodiment

In the first embodiment, the imaging device 100 manages the consent information 1500 of the subject, but the present disclosure is not limited thereto. In a second embodiment, a server 50, which will be described later, manages consent information of the subject. Hereinafter, differences from the first embodiment will be described.

FIG. 1D is a schematic view of the imaging system according to a second embodiment. An imaging system 20 includes the imaging device 100 which images the subject, the portable terminal 500, and the server 50. The imaging device 100 is a digital still camera, and is, for example, an interchangeable lens camera. The portable terminal 500 is a portable terminal belonging to the subject, and is, for example, a PC, a smartphone, or a tablet.

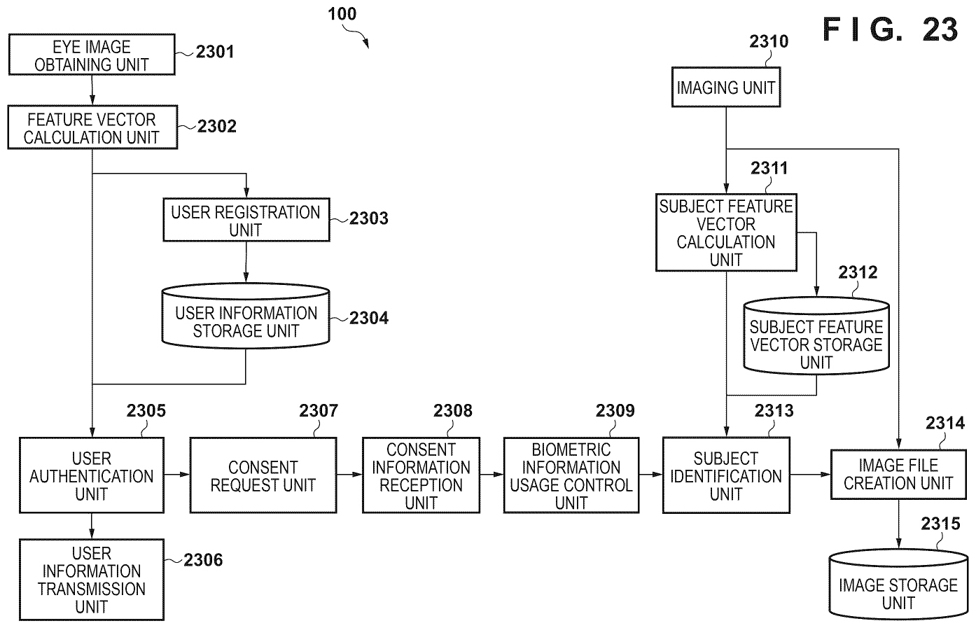

FIG. 23 is a view illustrating a functional configuration of the imaging device according to the second embodiment.

An eye image obtaining unit 2301 includes functions similar to those of the eye image obtaining unit 401. A feature vector calculation unit 2302 includes functions similar to those of the feature vector calculation unit 402. A user registration unit 2303 includes functions similar to those of the user registration unit 403. A user information storage unit 2304 includes functions similar to those of the user information storage unit 404. A user authentication unit 2305 includes functions similar to those of the user authentication unit 405. A consent request unit 2307 includes functions similar to those of the consent request unit 406. An imaging unit 2310 includes functions similar to those of the imaging unit 410. A subject feature vector calculation unit 2311 includes functions similar to those of the subject feature vector calculation unit 411. A subject feature vector storage unit 2312 includes functions similar to those of the subject feature vector storage unit 412. A subject identification unit 2313 includes functions similar to those of the subject identification unit 413. A biometric information usage control unit 2309 includes functions similar to those of the biometric information usage control unit 409. An image storage unit 2315 includes functions similar to those of the image storage unit 415. An image file creation unit 2314 includes functions similar to those of the image file creation unit 414.

A user information transmission unit 2306 transmits user information from the imaging device 100 to the server 50.

A consent information reception unit 2308 receives consent information from the server 50.

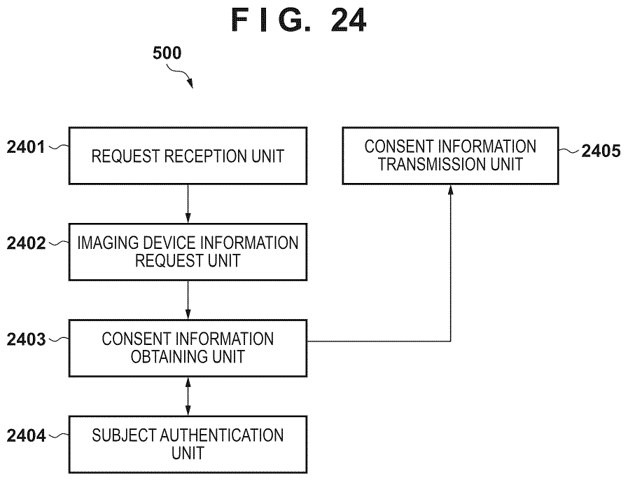

FIG. 24 is a view illustrating a functional configuration of the portable terminal according to the second embodiment.

A request reception unit 2401 includes functions similar to those of the request reception unit 601. A consent information obtaining unit 2403 includes functions similar to those of the consent information obtaining unit 602. A subject authentication unit 2404 includes functions similar to those of the subject authentication unit 603. A consent information transmission unit 2405 includes functions similar to those of the consent information transmission unit 604.

An imaging device information request unit 2402 obtains, from the server 50, information of the imaging device 100, which requests transmission of consent information and belongs to the user (photographer).

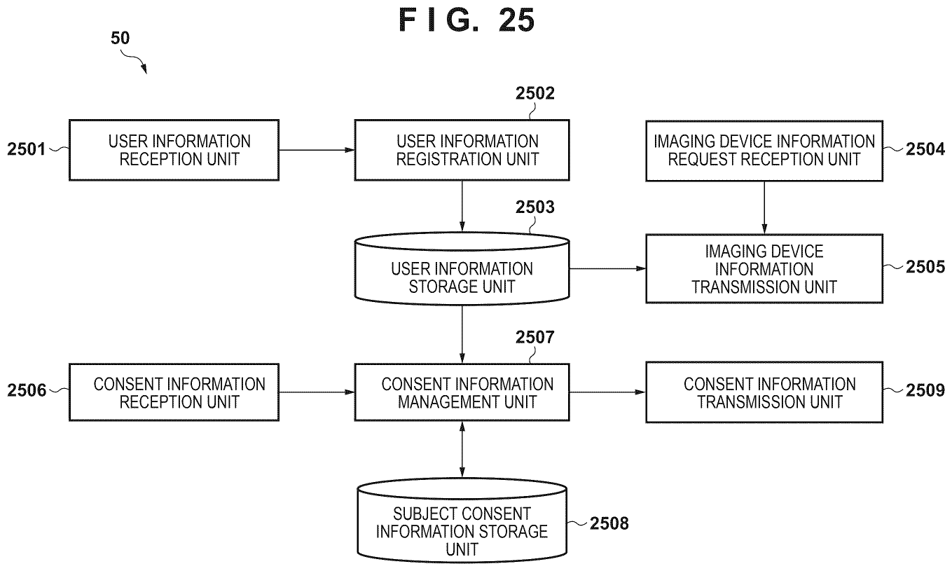

FIG. 25 is a view illustrating a functional configuration of the server according to the second embodiment. Since a hardware configuration of the server 50 is similar to that in FIG. 5, description will be omitted.

A user information reception unit 2501 is constituted by the network I/F 507. The user information reception unit 2501 receives user information (information of the photographer) from the imaging device 100.

A user information registration unit 2502 stores the user information received by the user information reception unit 2501 in a user information storage unit 2503.

The user information storage unit 2503 is constituted by the secondary storage device 504 and/or the RAM 503. The user information storage unit 2503 stores the user information received from the imaging device 100.

An imaging device information request reception unit 2504 is constituted by the network I/F 507. The imaging device information request reception unit 2504 receives, from the portable terminal 500, a request to transmit the user information of the imaging device 100.

An imaging device information transmission unit 2505 is constituted by the network I/F 507. The imaging device information transmission unit 2505 reads out, from the user information storage unit 2503, the user information of the imaging device 100, which is requesting transmission of consent information, and transmits the user information to the portable terminal 500.

A consent information reception unit 2506 is constituted by the network I/F 507. The consent information reception unit 2506 receives consent information from the portable terminal 500.

A consent information management unit 2507 associates the consent information from the portable terminal 500 and the user information stored in the user information storage unit 2503 with each other.

A subject consent information storage unit 2508 manages the consent information of the subject that has been associated with the user information by the consent information management unit 2507.

A consent information transmission unit 2509 transmits the consent information of the subject to the imaging device 100.

A flow of processing according to the second embodiment will be described. The processing is executed in generally the same manner as in FIG. 7. However, in the present embodiment, since the server 50 is used, “biometric information usage consent obtainment and management processing (step S702)” according to the second embodiment slightly differs from the processing of FIG. 7. Since the user information registration processing according to the second embodiment is similar to step S701 according to the first embodiment, description will be omitted.

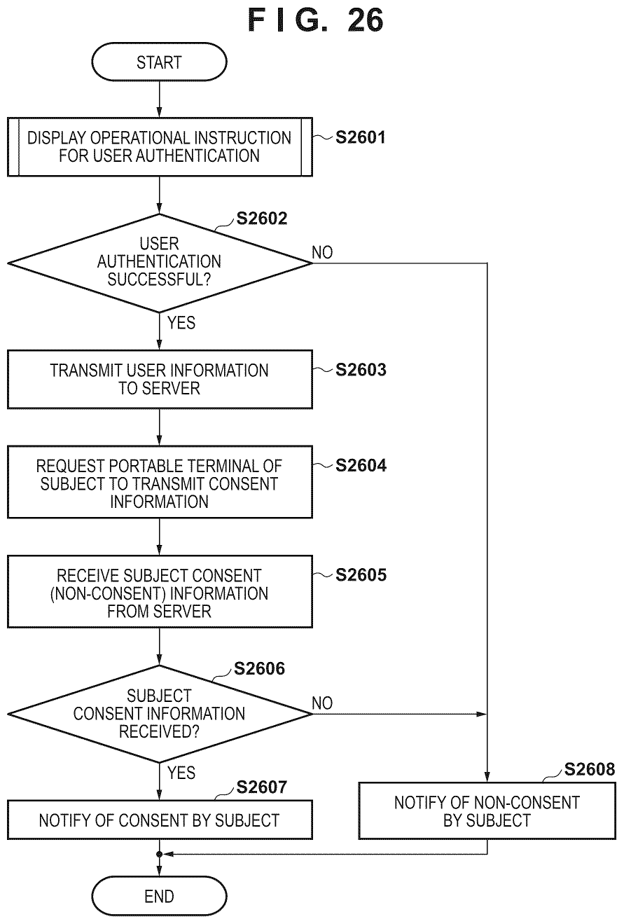

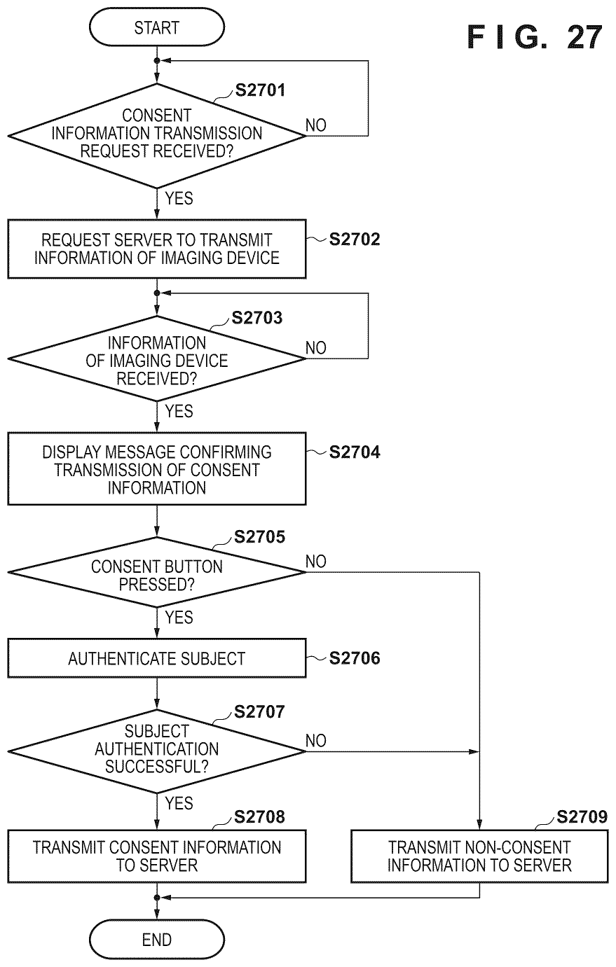

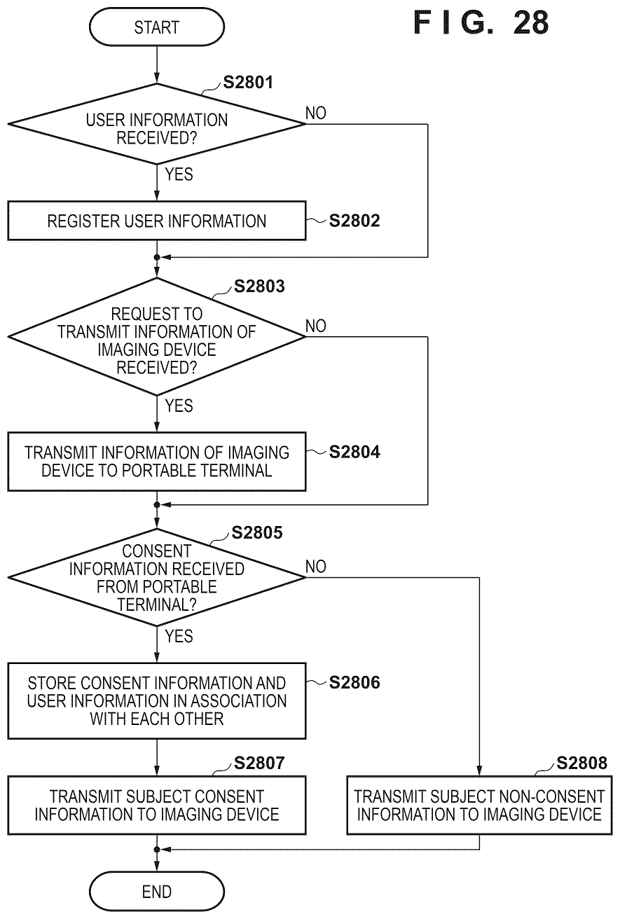

FIG. 26 is a flowchart for explaining processing to be executed by the imaging device according to the second embodiment. FIG. 27 is a flowchart for explaining processing to be executed by the portable terminal according to the second embodiment. FIG. 28 is a flowchart for explaining processing to be executed by the server according to the second embodiment. The processing of FIGS. 26 to 28 indicate detailed processing of “biometric information usage consent obtainment and management processing (step S702)” according to the first embodiment. First, the processing of FIG. 26 will be described.

In step S2601, the user authentication unit 2305 of the imaging device 100 performs user authentication.

In step S2602, the imaging device 100 determines whether user authentication has been successful. If it is determined that user authentication has been successful (YES in step S2602), the imaging device 100 advances the processing to step S2603. If it is determined that user authentication has not been successful (NO in step S2602), the imaging device 100 advances the processing to step S2608.

In step S2603, the user information transmission unit 2306 transmits user information to the server 50.

The user information includes the name of the user and the model name of the imaging device 100.

Here, in step S2801 of FIG. 28, the user information reception unit 2501 of the server 50 determines whether user information has been received from the imaging device 100. If it is determined that user information has been received from the imaging device 100 (YES in step S2801), the user information reception unit 2501 advances the processing to step S2802. Meanwhile, if it is determined that user information has not been received from the imaging device 100 (NO in step S2801), the user information reception unit 2501 advances the processing to step S2803.

In step S2802, the user information registration unit 2502 registers the user information in the user information storage unit 2503.

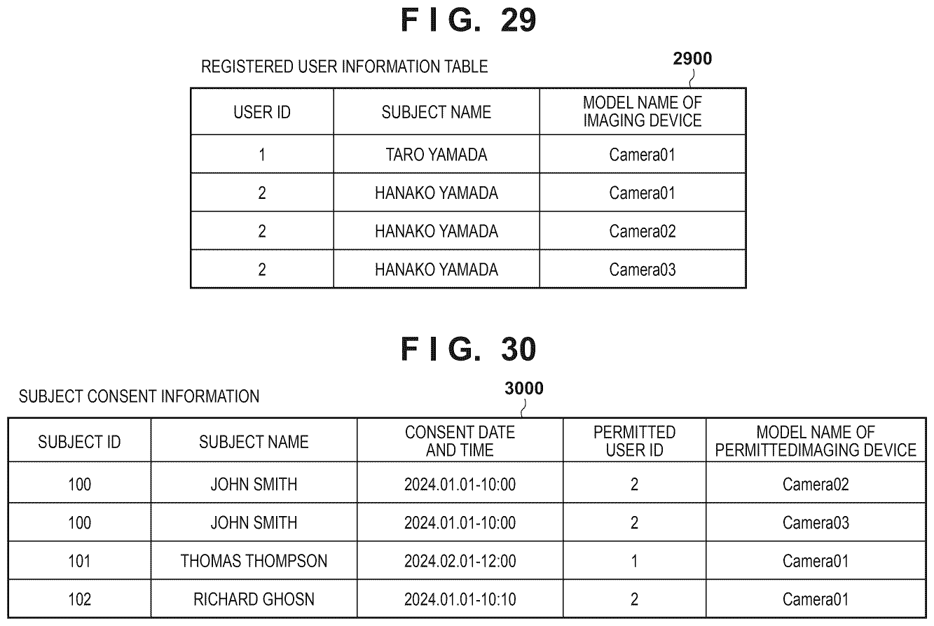

The user information is registered in the registered user information table 900 as described in step S805 according to the first embodiment. However, considering a case where one user (photographer) uses a plurality of imaging devices 100, the item of the model name of the imaging device 100 can be added to the registered user information table 900 (see FIG. 29).

FIG. 29 illustrates an example of a registered user information table according to the second embodiment.

A registered user information table 2900 includes a user ID, a user name, and a model name of the imaging device. Three models (Camera01, Camera02, Camera03) are registered as the model names of imaging devices that satisfy conditions of “user ID=2” and “user name=Hanako Yamada”. Here, the description of FIG. 26 is returned to.

In step S2604, the consent request unit 2307 of the imaging device 100 transmits a consent information transmission request to the portable terminal 500 of the subject. The consent information transmission request includes a predetermined code and a user name authenticated in step S2601.

In step S2701, the request reception unit 2401 of the portable terminal 500 determines whether a consent information transmission request has been received from the imaging device 100. If it is determined that a consent information transmission request has been received from the imaging device 100 (YES in step S2701), the request reception unit 2401 advances the processing to step S2702. If it is determined that a consent information transmission request has not been received from the imaging device 100 (NO in step S2701), the request reception unit 2401 waits until a consent information transmission request is received.

In step S2702, the imaging device information request unit 2402 transmits, to the server 50, a request to transmit information of the imaging device 100 (e.g., the model name of the imaging device), which is a source of the consent information transmission request and belongs to the user. The request to transmit information of the imaging device 100 includes a predetermined code, a user ID, and a user name. Here, the description of FIG. 28 is returned to.

In step S2804, the imaging device information transmission unit 2505 reads out the information of the imaging device 100 (model name of the imaging device) from the user information storage unit 2503 based on the user ID and the user name.

Then, the imaging device information transmission unit 2505 transmits the information of the imaging device 100 to the portable terminal 500. For example, when conditions that includes “user ID=2” and “user name=Hanako Yamada” (see FIG. 29) are assumed, the imaging device information transmission unit 2505 transmits information of three models (Camera01, Camera02, and Camera03) of imaging devices to the portable terminal 500. Here, the description of FIG. 27 is returned to.

In step S2703, the imaging device information request unit 2402 of the portable terminal 500 determines whether the information (model names: Camera01, Camera02, and Camera03) of the imaging device 100 has been received from the server 50. If it is determined that the information of the imaging device 100 has been received from the server 50 (YES in step S2703), the imaging device information request unit 2402 advances the processing to step S2704. Meanwhile, if it is determined that the information of the imaging device 100 has not been received from the server 50 (NO in step S2703), the imaging device information request unit 2402 waits until the information of the imaging device 100 is received.

In step S2704, the consent information obtaining unit 2403 displays two confirmation messages (see FIGS. 14 and 31) on the screen of the portable terminal 500.

As the confirmation message, a message similar to that of FIG. 14 of the first embodiment can be given, but the present disclosure is not limited thereto. In the second embodiment, the portable terminal 500 has received the information (model name) of the imaging device 100 and thus a confirmation message different from FIG. 14 may further be displayed.

FIG. 31 illustrates an example of a confirmation message to be displayed on the portable terminal according to the second embodiment.

A screen 3101 includes a region 3102. A template in which the user name that has made the consent information transmission request (“Hanako Yamada” in FIG. 31) is reflected is displayed in the region 3102. The template includes a message “Equipment belonging to ‘photographer: (user name)’ are as follows. Remove check from equipment you do not want to be used.”

Based on the information of the imaging device received from the server 50, a thumbnail image 3103, a thumbnail image 3104, and a thumbnail image 3105, which indicate the models of the imaging devices, are displayed on the screen 3101. In addition to these thumbnail images, text (not illustrated) indicating the model names of the imaging devices 100 may be displayed on the screen 3101. Furthermore, a check box 3106, a check box 3107, and a check box 3108 are displayed on the screen 3101. The user can select at least one of the check box 3106 to the check box 3108. An OK button 3109 is a button for confirming models of imaging devices that are not allowed to use biometric information. Here, the description of FIG. 27 is returned to.

In step S2705, the consent information obtaining unit 2403 determines whether the YES button 1403 of FIG. 14 and the OK button 3109 of FIG. 31 have been pressed. If it is determined that the YES button 1403 and the OK button 3109 have been pressed (YES in step S2705), the consent information obtaining unit 2403 advances the processing to step S2706. Meanwhile, if it is determined that the YES button 1403 and the OK button 3109 have not been pressed (NO in step S2705), the consent information obtaining unit 2403 advances the processing to step S2709.

The processing of step S2706 is similar to that of step S1304. The processing of step S2707 is similar to that of step S1305. The processing of step S2708 is similar to that of step S1306, but a transmission destination of consent information is not the imaging device 100 but the server 50. The processing of step S2709 is similar to that of step S1307, but a transmission destination of consent information is not the imaging device 100 but the server 50. Here, the description of FIG. 28 is returned to.

In step S2805, the consent information reception unit 2506 of the server 50 determines whether consent information has been received from the portable terminal 500. If it is determined that consent information has been received from the portable terminal 500 (YES in step S2805), the consent information reception unit 2506 advances the processing to step S2806. Meanwhile, if it is determined that consent information has not been received from the portable terminal 500 (NO in step S2805), the consent information reception unit 2506 advances the processing to step S2808.

In step S2806, the consent information management unit 2507 stores subject consent information (see FIG. 30), in which consent information and user information are associated with each other, in the subject consent information storage unit 2508.

FIG. 30 illustrates an example of subject consent information according to the second embodiment.

Compared with FIG. 16 of the first embodiment, in subject consent information 3000 of FIG. 30, the model name of the permitted imaging device has been added. For example, “subject name=John Smith” with “subject ID=100” has consented that “model name of permitted imaging device=Camera02 and Camera03” of “permitted user ID=2” uses biometric information. Here, the description of FIG. 28 is returned to.

In step S2807, the consent information transmission unit 2509 of the server 50 transmits the subject consent information 3000 to the imaging device 100. When assuming the subject ID=100 of the subject consent information 3000, the consent information transmission unit 2509 transmits the subject consent information 3000 (subject ID and subject name) to the imaging device (Camera02 and Camera03).

In step S2808, the server 50 can disable the biometric information usage function of the imaging device 100 by setting a NULL value to each of the subject ID and the subject name in the subject consent information 3000. The server 50 transmits the subject non-consent information (not illustrated) in which the subject consent information 3000 has been nullified to the imaging device 100. Here, the description of FIG. 26 is returned to.

In step S2605, the consent request unit 2307 of the imaging device 100 receives the subject consent information 3000 or the subject non-consent information (not illustrated) from the server 50. The consent request unit 2307 stores the subject consent information 3000 or the subject non-consent information (not illustrated) received from the server 50 in the memory unit 213.

In step S2606, the imaging device 100 references the subject consent information 3000 or the subject non-consent information (not illustrated) and determines whether a consent of the subject has been obtained. If the subject consent information 3000 has been received, the imaging device 100 determines that a consent of the subject has been obtained. Meanwhile, if the subject non-consent information (not illustrated) has been received, the imaging device 100 determines that a consent of the subject has not been obtained.

If it is determined that a consent of the subject has been obtained (YES in step S2606), the imaging device 100 advances the processing to step S2607. Meanwhile, if it is determined that a consent of the subject has not been obtained (NO in step S2606), the imaging device 100 advances the processing to step S2608.

In step S2607, the imaging device 100 displays a screen that notifies the user that a consent of the subject for the use of biometric information has been obtained on the touch panel (operation member 103) and/or the display device 214. For example, the imaging device 100 can display a message “Consent of the subject has been obtained!” on the screen.

In step S2606, a screen that notifies the user that a consent of the subject for the use of biometric information has not been obtained is displayed on the touch panel (operation member 103) and/or the display device 214. For example, the imaging device 100 can display a message “Consent of the subject has not been obtained.” on the screen.

Next, the biometric information usage preparation processing (step S703) according to the second embodiment will be described regarding differences from the first embodiment.

In step S1704, the list of consenting subjects is created based on the subject consent information that the consent information reception unit 2308 has received from the server 50. The consent information management unit 2507 of the server 50 references “permitted user” and “model name of permitted imaging device” in the subject consent information 3000. Then, the consent information management unit 2507 reads out all of the user ID of the imaging device of the transmission destination, the subject ID corresponding to the model of the imaging device, the subject name, and the consent date and time, and creates the subject consent information.

Since the biometric information usage processing (step S704) according to the second embodiment is similar to that of the first embodiment, description will be omitted.

As described above, according to the second embodiment, when one user (photographer) uses a plurality of imaging devices (models), the subject does not need to give consent information, which consents to the use of biometric information for each imaging device. That is, the subject can simply specify the model of the imaging device that uses the biometric information. In addition, the user need only register the model of the imaging device once.

### Supplement

In the second embodiment, the server 50 manages the consent information, but the portable terminal 500 of the subject may manage the consent information. In this case, the portable terminal 500 of the subject manages the information of the user, which includes the ID, the user name, and the model of the imaging device of the user to which the consent information is transmitted, and the consent information, which includes the consent date and time, in association with each other.

In the first embodiment and the second embodiment, the user name is registered in the registered user information table 900 and a registered user information table 2900, but a thumbnail image of the face of the user may be registered in addition to the user name. With this, since the thumbnail image of the face of the user is displayed in FIG. 14, there is an advantage that it is easy for the subject to confirm the user to whom they want to transmit consent information.

The portable terminal 500 is the portable terminal 500 belonging to the subject, but need not necessarily be the portable terminal 500 belonging to the subject. The portable terminal 500 may be, for example, the portable terminal 500, which is provided in a photo studio or the like.

Further, the consent information obtaining unit 602 is present in the portable terminal 500, but may be present in the imaging device 100. The imaging device 100, for example, may obtain the consent information of the subject based on the operation (sign or gesture) of the subject (see Patent Document 1).

Further, metadata may include the following items. The user information may include a model name, a manufacturer name, and an individual number of the imaging device 100. This makes it possible to indicate to the subject or the like that an imaging device supports authenticity assurance, such as C2PA, has been used. A subject consent item may include a model name, an individual number, and a MAC address at the time of communication of the portable terminal used for consent. This makes it possible to leave evidence that indicates that the consent information of the subject has been obtained through a correct procedure. Further, by using these kinds of metadata, it is possible to identify, from an image file, which subject has granted consent to use biometric information to the model of the imaging device of which user.

Further, the biometric information usage control unit 409 and the biometric information usage control unit 2309 control the extraction of subject features, a function that uses biometric information (subject identification function), and the output of metadata, but may perform any control so long as the control is based on a consent of the subject. If the consent information of the subject cannot be obtained, the biometric information usage control unit 409 and the biometric information usage control unit 2309 may, for example, perform control for not transmitting an image file, and control for masking the region of the subject so as not to be viewed when displaying a captured image.

Further, in the present disclosure, the holder of the biometric information (subject) can specify the user and the device (imaging device) to be using the biometric information, and only the specified user and device can use the biometric information. For example, if the biometric information is an X-ray image, the holder of the biometric information is a patient, the user of the biometric information may be a doctor or an X-ray technician that performs imaging upon an instruction of the doctor.

An example of a situation in which the present disclosure is applied will be described. For example, a situation in which the subject consents to obtainment of biometric information (X-ray imaging) is assumed. The subject undergoes X-ray imaging after receiving an explanation of X-ray imaging from a doctor. Here, a situation such as that in which the subject consents to obtainment of biometric information after confirming the doctor (and X-ray technician) from a terminal or the like provided at the hospital is considered.

By performing control for not allowing imaging of the subject when an X-ray device cannot confirm the consent information, it becomes possible to prevent mix-up of patients.

In addition, the present disclosure can be applied to an Automatic Teller Machine (ATM) using face, vein, and fingerprint authentication of a subject. In particular, face authentication has a risk of spoofing, customers may feel resistance to the use of face authentication. However, customers may consider that face authentication may be used with a specific ATM near their home. By the customer specifying an ATM using a terminal of the bank and/or their home PC, a consent to use biometric information can be given to those terminals and the like. For example, a customer can have only an ATM near their home execute face authentication of the customer.

The object of the present disclosure may be realized by the following method. A recording medium (or storage medium) in which software program code that realizes the functions of the above embodiments is recorded is supplied to a system or apparatus. Then, the computer (or a CPU, MPU, or GPU) of the system or apparatus reads and executes the program code stored in the recording medium. In this case, the program code read from the recording medium itself realizes the functions of the above embodiments, and the recording medium in which that program code is recorded constitutes the present disclosure.

Further, the function of the above embodiments is not only realized by the computer executing the read program code. A case where an operating system (OS) or the like operating on the computer performing part or all of the actual processing based on instructions of the program code is also included.

Furthermore, a case where the functions of the above embodiments are realized by the following method is also included. The program code read from the recording medium is written into a memory included in a function expansion card inserted into the computer or a function expansion unit connected to the computer. Then, a CPU or the like included in the function expansion card or the function expansion unit performs part or all of the actual processing based on instructions of the program code.

When the present disclosure is applied to the above recording medium, program code that corresponds to the flowcharts described above is stored in the recording medium.

The disclosure is not limited to the above embodiments, and various modifications and variations are possible without departing from the spirit and scope of the disclosure. Accordingly, claims are attached to make the scope of disclosure public.

According to the present disclosure, it is possible to provide a technique that allows a specific target to use biometric information of a subject.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-131207, which was filed on Aug. 7, 2024 and which is hereby incorporated by reference herein in its entirety.

What is claimed is:

1. An imaging device configured to image a subject, the imaging device comprising:
at least one processor; and
at least one memory coupled to the at least one processor, the at least one memory storing instructions that, when executed by the at least one processor, cause the at least one processor to:
authenticate a user; and
based on subject consent information in which user information of the authenticated user and consent information, which grants the user consent to use biometric information of the subject, are associated with each other, control use of the biometric information.

2. The imaging device according to claim 1, wherein
the consent information grants both the user and an imaging device belonging to the user consent to use the biometric information of the subject.

3. The imaging device according to claim 1, wherein
the instructions further cause the at least one processor to obtain the consent information from a first terminal belonging to the subject or a second terminal other than the first terminal.

4. The imaging device according to claim 1, wherein
the instructions further cause the at least one processor to perform control for limiting storage, distribution, and display of the biometric information based on the subject consent information.

5. The imaging device according to claim 1, wherein
the instructions further cause the at least one processor to output an image file to which the user information and the consent information have been added as metadata of an image in which the subject is captured.

6. The imaging device according to claim 1, wherein
the user is authenticated based on an eye image obtained from the user.

7. An imaging device configured to image a subject, the imaging device comprising:
at least one processor; and
at least one memory coupled to the at least one processor, the at least one memory storing instructions that, when executed by the at least one processor, cause the at least one processor to:
based on subject consent information in which information of the imaging device and consent information, which grants the imaging device consent to use biometric information of the subject, are associated with each other, control use of the biometric information.

8. The imaging device according to claim 7, wherein
the instructions further cause the at least one processor to obtain the consent information from a first terminal belonging to the subject or a second terminal other than the first terminal.

9. The imaging device according to claim 7, wherein
the instructions further cause the at least one processor to perform control for limiting storage, distribution, and display of the biometric information based on the subject consent information.

10. The imaging device according to claim 7, wherein
the instructions further cause the at least one processor to output an image file to which the information of the imaging device and the consent information have been added as metadata of an image in which the subject is captured.

11. An imaging system comprising:
the imaging device according to claim 1, which is configured to image the subject; and
a terminal,
the terminal comprising:
at least one second processor; and
at least one second memory coupled to the at least one second processor, the at least one second memory storing instructions that, when executed by the at least one second processor, cause the at least one second processor to:
transmit the consent information to the imaging device based on an instruction to transmit the consent information.

12. The imaging system according to claim 11, wherein the terminal
authenticates a subject that uses the terminal, and
based on a result of authenticating the subject that uses the terminal and the consent information, controls use of the biometric information.

13. An imaging system comprising:
a server; and
the imaging device according to claim 7, which is configured to image the subject,
the server comprising:
at least one second processor; and
at least one second memory coupled to the at least one second processor, the at least one second memory storing instructions that, when executed by the at least one second processor, cause the at least one second processor to:
register user information of a user authenticated by the imaging device, and information of one or more imaging devices including the imaging device that are associated with the user information;
manage subject consent information in which the user information, the information of the one or more imaging devices, and consent information, which grants both the user and the one or more imaging devices consent to use biometric information of the subject, are associated with each other; and
in a case where the consent information is received from a terminal belonging to the subject, transmit the subject consent information to the imaging device,
wherein the imaging device receives the subject consent information from the server.

14. The imaging system according to claim 13, wherein
the server obtains the consent information from the terminal belonging to the subject or a terminal other than the terminal belonging to the subject.

15. The imaging system according to claim 13, wherein
the instructions further cause the at least one second processor to perform control for limiting storage, distribution, and display of the biometric information based on the subject consent information.

16. The imaging system according to claim 13, wherein
the imaging device outputs an image file to which the user information and the consent information have been added as metadata of an image in which the subject is captured.

17. The imaging system according to claim 13, further comprising:
a terminal configured to communicate with each of the server and the imaging device,
wherein the terminal:
authenticates the subject, and
based on a result of authenticating the subject and the consent information, controls use of the biometric information.

18. The imaging system according to claim 13, wherein
the terminal belonging to the subject inputs information of an imaging device to be granted consent to use the biometric information from the information of the one or more imaging devices, and
the imaging device output an image file to which the user information, the consent information, and a result of the input have been added as metadata of an image in which the subject is captured.

19. A method to control an imaging device configured to image a subject, the method comprising:
authenticating a user; and
based on subject consent information in which user information of the authenticated user and consent information, which grants the user consent to use biometric information of the subject, are associated with each other, controlling use of the biometric information.

20. A non-transitory computer-readable storage medium storing a computer program that, when read and executed by a computer, causes the computer to:
authenticate a user; and
based on subject consent information in which user information of the authenticated user and consent information, which grants the user consent to use biometric information of the subject, are associated with each other, control use of the biometric information.
